(19) United States
(12) Patent Application Publication
(10) Pub. No.: US 2026/0023334 A1
(43) Pub. Date: Jan. 22, 2026

(54) ELECTROSTATIC CHARGE IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yasuo KADOKURA, Kanagawa (JP); Moegi IGUCHI, Kanagawa (JP); Ryo NAGAI, Kanagawa (JP); Yosuke TSURUMI, Kanagawa (JP)

(73) Assignee: FUJIFILM Business Innovation Corp., Tokyo (JP)

(21) Appl. No.: 19/043,525

(22) Filed: Feb. 3, 2025

(30) Foreign Application Priority Data
Jul. 19, 2024 (JP) 2024-116297

(51) Int. Cl. G03G 9/113; G03G 9/087; G03G 9/107; G03G 21/18

(52) U.S. Cl. CPC G03G 9/1139; G03G 9/08755; G03G 9/107; G03G 21/1814; G03G 2215/066

(57) ABSTRACT

An electrostatic charge image developer contains a carrier and a toner, in which the carrier has magnetic particles, a resin coating layer that coats the magnetic particles, and inorganic particles contained in the resin coating layer, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less; and the toner contains toner particles, and in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.

### CROSS-REFERENCE TO RELATED APPLICATIONS

This application is based on and claims priority under 35 USC 119 from Japanese Patent Application No. 2024-116297 filed Jul. 19, 2024.

### BACKGROUND

### (i) Technical Field

The present disclosure relates to an electrostatic charge image developer, a process cartridge, an image forming apparatus, and an image forming method.

### (ii) Related Art

JP2024-046535A discloses an electrostatic charge image developer containing a toner A in which silica particles (A) containing a nitrogen element-containing compound containing a molybdenum element are externally added to toner particles containing a binder resin and resin particles, and a carrier B that contains a core material and a coating resin layer coating the core material and containing inorganic particles, in which a ratio N_{Mo}/N_{Si} of an Net intensity N_{Mo} of the molybdenum element to an Net intensity N_{Si} of a silicon element, that are measured by X-ray fluorescence analysis of the silica particles (A), is 0.035 or more and 0.45 or less.

JP2022-181065A discloses an electrostatic charge image developing carrier that has magnetic particles and a resin layer containing silica particles having an average particle size of 50 nm or more and 200 nm or less, the resin layer coating the magnetic particles, in which a proportion Si1 of an Si element in a region at a distance of 0.1 μm or more and 0.2 μm or less from a surface of the resin layer in an internal direction and a proportion Si2 of an Si element in a region at a distance of 0.0 μm or more and 0.1 μm or less from a surface of the magnetic particles in a surface direction of the resin layer satisfy an expression 1-1: 0.005≤Si1 and an expression 2-1: 1≤Si1/Si2≤1000.

JP2012-093629A discloses an electrophotographic carrier including a core material and a resin layer that coats the core material, in which an expression (1): 1≤(S×r×D)/3≤1.5 [S represents a BET specific surface area (m²/g) of the carrier, r represents an average particle radius (m) of the carrier, and D represents a density (g/m³) of the carrier] is satisfied.

### SUMMARY

Aspects of non-limiting embodiments of the present disclosure relate to an electrostatic charge image developer that has excellent stability of an image density.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following. Each formula is the same as the formula having the same number described later.

According to an aspect of the present disclosure, there is provided an electrostatic charge image developer containing a carrier and a toner, in which the carrier has magnetic particles, a resin coating layer that coats the magnetic particles, and inorganic particles contained in the resin coating layer, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less; and the toner contains toner particles, and in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit value or lower limit value of a numerical range may be replaced with values described in examples.

In the present disclosure, “A and/or B” is synonymous with “at least one of A or B”. That is, “A and/or B” represents that A alone may be used, B alone may be used, or a combination of A and B may be used.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, “(meth)acrylic” is an expression including both acrylic and methacrylic, and “(meth)acrylate” is an expression including both acrylate and methacrylate.

In the present disclosure, a “toner” refers to an “electrostatic charge image developing toner”, a “developer” refers to an “electrostatic charge image developer”, and a “carrier” refers to an “electrostatic charge image developing carrier”.

### Electrostatic Charge Image Developer

The developer according to the present disclosure contains the following carrier and the following toner.

Carrier: having magnetic particles, a resin coating layer that coats the magnetic particles, and inorganic particles contained in the resin coating layer, in which the resin coating layer contains inorganic particles, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

In the resin coating layer of the carrier according to the present disclosure, carbon black is not included in the inorganic particles.

Toner: containing toner particles, in which, in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.

In a case where a developer in the related art is used for image formation in which a part where a toner and a carrier are in contact with each other is likely to generate heat and a mechanical load is applied for a long period of time (for example, image formation in a high-temperature and high-humidity environment (for example, a temperature of 25° C. and a relative humidity of 90%) with a large amount of a low-density image (for example, an image density of 0.5%)), an external additive is embedded in the toner and a resin coating layer of the carrier is peeled off, and thus frictional charging of the toner is changed; and then image formation is performed in a low-temperature and low-humidity environment (for example, a temperature of 10° C. and a relative humidity of 15%) with a large amount of a high-density image (for example, an image density of 100%), the image density may become unstable.

On the other hand, the developer according to the present disclosure has excellent stability of an image density by the combination of the above-described carrier and the above-described toner.

In a case where the value of B−A of the carrier is less than 0.5 atm %, when the surface of the carrier is worn due to stress in a developing device, inorganic particles appearing on the surface of the carrier are too few, heat is likely to be generated in a part where the toner and the carrier are in contact with each other, the external additive is embedded in the toner, the resin coating layer of the carrier is likely to be peeled off, favorable stirring performance between the toner and the carrier is impaired, the frictional charging of the toner is likely to be charged, and the image density is likely to be unstable. From the viewpoint of suppressing the present phenomenon, the value of B−A of the carrier is 0.5 atm % or more, for example, preferably 0.8 atm % or more, more preferably 1.0 atm % or more, and still more preferably 1.2 atm % or more.

In a case where the value of B−A of the carrier is more than 3.0 atm %, when the surface of the carrier is worn due to stress in a developing device, inorganic particles appearing on the surface of the carrier are too many, the surface of the carrier is hardened, the external additive is embedded in the toner, favorable stirring performance between the toner and the carrier is impaired, the frictional charging of the toner is likely to be charged, and the image density is likely to be unstable. From the viewpoint of suppressing the present phenomenon, the value of B−A of the carrier is 3.0 atm % or less, for example, preferably 2.7 atm % or less, more preferably 2.5 atm % or less, and still more preferably 2.3 atm % or less.

In a case where the minimal value tan δ(min) of the loss tangent of the toner particles is less than 0.50, the external additive is likely to be embedded due to a synergistic effect of the excessive viscosity of the toner and the heat generated at a part where the toner and the carrier are in contact with each other due to the stress in a developing machine, favorable stirring performance between the toner and the carrier is impaired, the frictional charging is likely to be charged, and the image density is likely to be unstable. From the viewpoint of suppressing the present phenomenon, the minimal value tan δ(min) of the loss tangent of the toner particles is 0.50 or more, for example, preferably 0.60 or more, and more preferably 0.70 or more.

In a case where the minimal value tan δ(min) of the loss tangent of the toner particles is more than 1.00, the external additive is likely to be released due to excessively high elasticity of the toner, that may cause the carrier to be contaminated and the charge to be reduced. In addition, favorable stirring performance between the toner and the carrier is impaired, the frictional charging is likely to be charged, and the image density is likely to be unstable. From the viewpoint of suppressing the present phenomenon, the minimal value tan δ(min) of the loss tangent of the toner particles is 1.00 or less, and is, for example, preferably 0.96 or less, and more preferably 0.90 or less.

The developer according to the present disclosure is a two-component developer in which a toner and a carrier are mixed at an appropriate blending proportion. The mixing ratio (mass ratio) between the toner and the carrier, represented by toner:carrier, is, for example, preferably 1:100 to 30:100, and more preferably 3:100 to 20:100.

Hereinafter, the carrier and the toner will be described in detail.

### Electrostatic Charge Image Developing Carrier

### Value of B−A

In the carrier according to the present disclosure, in a case where an element ratio of metals and metalloids, that constitute the inorganic particles contained in the resin coating layer, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less.

From the viewpoint of image density stability, the value of B−A is, for example, preferably 0.8 atm % or more and 2.7 atm % or less, more preferably 1.0 atm % or more and 2.5 atm % or less, and still more preferably 1.2 atm % or more and 2.3 atm % or less.

A method of element analysis in the depth direction and a method of measuring the element ratios A and B by X-ray photoelectron spectroscopy (XPS) are as follows.

The carrier is used as a sample of XPS, and elements are analyzed while etching is carried out. The elements to be analyzed are carbon, nitrogen, oxygen, iron, manganese, and metals and metalloids constituting the inorganic particles. In a case where the metals and the metalloids constituting the inorganic particles are unknown, the metals and the metalloids constituting the inorganic particles are specified by performing a total element analysis of the carrier in advance. Examples of the metal element constituting the inorganic particles include aluminum and titanium. Examples of the metalloid element constituting the inorganic particles include silicon, boron, germanium, arsenic, antimony, and tellurium.

A proportion of the total element amount of the metals and the metalloids constituting the inorganic particles to the total element amount of all elements to be analyzed is defined as the element ratio (atm %) of the metals and the metalloids constituting the inorganic particles. That is, the element ratio (atm %) of the metals and the metalloids constituting the inorganic particles is (Total element amount of metals and metalloids constituting inorganic particles)/(Total element amount of carbon, nitrogen, oxygen, iron, manganese, and metals and metalloids constituting the inorganic particles)×100.

The above-described element ratio at 0 seconds of etching is defined as A (atm %) and the element ratio at 300 seconds of etching is defined as B (atm %). The 0 seconds of etching means that etching is not performed.

The above-described XPS is performed with the following device and conditions. The analysis is performed after baseline correction.
XPS device: PHI5000 Versa Probe H1 (ULVAC-PHI, Inc.)
X-ray source: monochromatic Al-Kα ray
Beam voltage: 15 kV
Emission current: 3 mA
Etching gun: argon gas cluster ion gun
Degree of vacuum: 1×10⁻⁵ Pa to 1×10⁻⁶ Pa
Pass Energy: 23.5 eV
Sweep region: 300 μm×300 μm
Time Per Step: 50 seconds
Cycle: 5 times
Sweep: 10 times

In a case of analyzing the carrier contained in the developer, examples of a method of separating the carrier from the developer include a method of removing the toner from the developer by air blowing using any mesh.

### Value of Element Ratio A

From the viewpoint of image density stability, a value of the element ratio A is, for example, preferably 2.0 atm % or more and 10.0 atm % or less, more preferably 2.5 atm % or more and 8.0 atm % or less, and still more preferably 3.0 atm % or more and 6.0 atm % or less. In a case where the element ratio A is within the above-described range, the abrasion due to the stress in the developing device is suppressed by formation of fine unevenness on the carrier surface by the inorganic particles and the carrier surface being appropriately hard by the inorganic particles, and as a result, the image density is stabilized.

### Value of Element Ratio B

From the viewpoint of image density stability, a value of the element ratio B is, for example, preferably 3.5 atm % or more and 12.0 atm % or less, more preferably 4.3 atm % or more and 9.8 atm % or less, and still more preferably 4.8 atm % or more and 7.8 atm % or less.

In a case where the element ratio B is 3.5 atm % or more, the amount of the inorganic particles exposed in a case where the carrier surface is scraped due to the stress in the developing device is not too small, the charging is not excessively increased, and as a result, the image density is stabilized.

In a case where the element ratio B is 12.0 atm % or less, the amount of the inorganic particles exposed in a case where the carrier surface is scraped due to the stress in the developing device is not too large, the charging is not excessively decreased, and as a result, the image density is stabilized.

### Method of Controlling Value of B−A

The value of B−A can be controlled, for example, by utilizing a sedimentation phenomenon of particles and/or Brazil nut phenomenon in a case of forming the resin coating layer.

The sedimentation phenomenon of particles is a phenomenon in which a sedimentation rate of the particles changes depending on a particle size and a shape of the particles, a density difference and an affinity between the particles and a dispersion medium, a density difference and an affinity between the particles and other components, a particle concentration, and the like. In general, in a case where the particle size of the particles in a liquid is smaller and the density of the particles is higher, the sedimentation rate of the particles is higher. The Brazil nut phenomenon is a phenomenon in which, in a case where a collection of a plurality of types of particles having different particle sizes is vibrated, particles having a large particle size rise.

In a case where the resin coating layer is formed by a wet manufacturing method, the particles can freely move in the liquid in which the resin is dissolved, so that the above-described phenomenon can be utilized.

Using the above-described phenomenon, the value of B−A is controlled by the material, the particle size, the density, and/or the concentration of the inorganic particles, the presence or absence of other particles, the type of the resin of the resin coating layer, the conditions for forming the resin coating layer, and the like.

In a case where the particle size of the inorganic particles is in an appropriate range, the inorganic particles are likely to be appropriately unevenly distributed on the lower side of the resin coating layer. In a case where particles having a particle size larger than the particle size of the inorganic particles are used in combination as the other particles, the inorganic particles are more likely to be unevenly distributed on the lower side of the resin coating layer. In a case where the other particles are particles having a lower density than the inorganic particles and/or particles having a different polarity, the inorganic particles are more likely to be unevenly distributed on the lower side of the resin coating layer. In a case where the concentration of the inorganic particles is in an appropriate range, the inorganic particles are likely to be appropriately unevenly distributed on the lower side of the resin coating layer. Even in a case where the concentration of the other particles is in an appropriate range, the inorganic particles are likely to be appropriately unevenly distributed on the lower side of the resin coating layer.

### Resin Coating Layer

### Resin

The carrier according to the present disclosure has a resin coating layer on a surface of the magnetic particles.

Examples of a resin configuring the resin coating layer include a styrene·acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride-vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea-formaldehyde resin; and an epoxy resin.

One kind of each of these resins may be used alone, or two or more kinds of these resins may be used in combination.

From the viewpoint of controlling the value of B−A and viewpoint of image density stability, for example, the resin coating layer preferably contains an acrylic resin having an aliphatic cyclic structure and an amino group, and more preferably contains an acrylic resin that has a constitutional unit having an aliphatic cyclic structure and a constitutional unit having an amino group.

As the aliphatic cyclic structure, for example, a cycloalkyl group is preferable, and a cyclohexyl group is more preferable.

Examples of the acrylic resin having a cyclohexyl group include a homopolymer of a (meth)acrylic monomer having a cyclohexyl group and a copolymer of a (meth)acrylic monomer having a cyclohexyl group and another monomer. Examples of the (meth)acrylic monomer having a cyclohexyl group include cyclohexyl acrylate and cyclohexyl methacrylate.

As the constitutional unit having an aliphatic cyclic structure, for example, a constitutional unit derived from cyclohexyl (meth)acrylate is preferable.

From the viewpoint of image density stability, for example, the acrylic resin that has a constitutional unit having an aliphatic cyclic structure preferably contains 80% by mass or more of the constitutional unit having an aliphatic cyclic structure.

As the (meth)acrylic monomer having an amino group, for example, dialkylaminoalkyl (meth)acrylate is preferable, and dimethylaminoethyl (meth)acrylate is more preferable.

From the viewpoint of image density stability, for example, the acrylic resin that has a constitutional unit having an amino group preferably contains 0.05% by mass or more and 5% by mass or less of the constitutional unit having an amino group, and more preferably contains 0.1% by mass or more and 2% by mass or less of the constitutional unit having an amino group.

### Inorganic Particles

The resin coating layer contains inorganic particles.

Examples of the inorganic particles include particles of a metal compound such as silica (silicon dioxide), titania (titanium oxide), alumina (aluminum oxide), zinc oxide, tin oxide, barium sulfate, aluminum borate, potassium titanate, antimony-doped tin oxide, indium-doped tin oxide, and zinc oxide-doped aluminum; particles of a metal such as gold, silver, and copper; and resin particles coated with a metal.

One kind of inorganic particles may be used alone, or two or more kinds of inorganic particles may be used in combination.

As the inorganic particles, from the viewpoint of excellent dispersibility in the resin and viewpoint of exhibiting the effect of preventing the abnormal increase or decrease in the charge by being appropriately exposed on the surface, for example, at least one selected from the group consisting of silica particles, titania particles, and alumina particles is preferable, and silica particles are more preferable.

From the viewpoint of image density stability, an average primary particle size of the inorganic particles is, for example, preferably 1 nm or more and 100 nm or less, more preferably 5 nm or more and 60 nm or less, still more preferably 5 nm or more and 40 nm or less, even more preferably 6 nm or more and 30 nm or less, and particularly preferably 7 nm or more and 20 nm or less.

In a case where the average primary particle size of the inorganic particles is 1 nm or more, the inorganic particles are less likely to aggregate with each other in a case of forming the resin coating layer, and as a result, the inorganic particles are likely to be unevenly distributed on the lower side of the resin coating layer.

In a case where the average primary particle size of the inorganic particles is 100 nm or less, the exposure on the surface of the resin coating layer is suppressed.

In the present disclosure, the primary particle size of the inorganic particles is a diameter of a circle having the same area as the primary particle image (so-called equivalent circle diameter), and the average primary particle size of the inorganic particles is a particle size at which a cumulative percentage from the small diameter side in the number-based distribution of the primary particle diameters is 50%. The primary particle size of the inorganic particles is determined by performing image analysis on at least 300 inorganic particles.

The inorganic particles contained in the resin coating layer may be simply inorganic particles or may be particles obtained by performing a hydrophobic treatment on a surface of the inorganic particles (may be referred to as “base particles”). From the viewpoint that the effect of preventing the aggregation of the inorganic particles is large, the affinity with the resin of the resin coating layer is increased, and the effect of preventing the abnormal increase or decrease in the charge is likely to be exhibited by being appropriately exposed on the surface, for example, inorganic particles that subjected to a surface treatment are preferable, and inorganic particles having a surface subjected to a hydrophobization treatment are more preferable.

The surface treatment of the inorganic particles is performed, for example, by preparing a treatment liquid obtained by mixing the silicon-containing organic compound that is a hydrophobizing agent with a solvent, mixing the inorganic particles with the treatment liquid under stirring, and further continuing the stirring. After the surface treatment, for the purpose of removing the solvent in the treatment liquid, a drying treatment is performed.

Examples of the silicon-containing organic compound used in the surface treatment for the inorganic particles include an alkoxysilane compound, a silazane compound, and a silicone oil. Among these, from the viewpoint of obtaining an effect of improving the dispersibility of the inorganic particles and preventing the aggregation due to the appropriate three-dimensional disorder, and from the viewpoint of easily exhibiting the effect of preventing the abnormal increase or decrease in the charge when the inorganic particles are appropriately present on the surface, for example, an alkoxysilane compound or a silazane compound is preferable, and a silazane compound is more preferable.

Examples of the alkoxysilane compound used in the hydrophobization treatment of the surface of the inorganic particles include tetramethoxysilane, tetraethoxysilane; methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane; dimethyldimethoxysilane, dimethyldiethoxysilane, methylvinyldimethoxysilane, methylvinyldiethoxysilane, diphenyldimethoxysilane, diphenyldiethoxysilane; and trimethylmethoxysilane and trimethylethoxysilane.

Examples of the silazane compound used in the hydrophobization treatment of the surface of the inorganic particles include dimethyldisilazane, trimethyldisilazane, tetramethyldisilazane, pentamethyldisilazane, and hexamethyldisilazane.

Examples of the silicone oil used in the surface treatment for the inorganic particles include silicone oils such as dimethylpolysiloxane, diphenylpolysiloxane, and phenylmethylpolysiloxane; and reactive silicone oils such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane.

The solvent used for preparing the treatment liquid is, for example, preferably an alcohol (for example, methanol, ethanol, propanol, or butanol) in a case where the silicon-containing organic compound is an alkoxysilane compound or a silazane compound, or preferably hydrocarbons (for example, benzene, toluene, normal hexane, and normal heptane) in a case where the silicon-containing organic compound is a silicone oil.

In the treatment liquid, a concentration of the silicon-containing organic compound is, for example, preferably 1% by mass or more and 50% by mass or less, more preferably 5% by mass or more and 40% by mass or less, and still more preferably 10% by mass or more and 30% by mass or less.

The amount of the silicon-containing organic compound used in the surface treatment is, for example, preferably 1 part by mass or more and 50 parts by mass or less, more preferably 5 parts by mass or more and 40 parts by mass or less, and still more preferably 5 parts by mass or more and 30 parts by mass or less with respect to 100 parts by mass of the inorganic particles.

A content of the inorganic particles in the resin coating layer is, for example, preferably 15% by mass or more and 35% by mass or less, more preferably 17% by mass or more and 30% by mass or less, and still more preferably 20% by mass or more and 25% by mass or less with respect to the total mass of the resin coating layer. In a case where the content of the inorganic particles is within the above-described range, the inorganic particles are likely to be appropriately unevenly distributed on the lower side of the resin coating layer.

A ratio (element ratio A/content of inorganic particles; atm %/% by mass) of the amount of the inorganic particles on the carrier surface (element ratio A, atm %) to the content of the inorganic particles in the resin coating layer (% by mass) is, for example, preferably 0.05 or more and 0.60 or less, more preferably 0.08 or more and 0.40 or less, and still more preferably 0.10 or more and 0.30 or less. In a case where the ratio of the amount of the inorganic particles on the carrier surface (element ratio A, atm %) to the content of the inorganic particles in the resin coating layer (% by mass) is within the above-described range, the carrier surface is appropriately hardened by the inorganic particles, and the inorganic particles are appropriately unevenly distributed on the lower side of the resin coating layer.

### Resin Particles

From the viewpoint of image density stability, for example, the resin coating layer preferably contains resin particles.

Examples of the resin particles include particles of a polymerized (meth)acrylic resin containing dimethylaminoethyl (meth)acrylate, dimethyl acrylamide, acrylonitrile, and the like; an amino resin such as urea, melamine, guanamine, or aniline; an amide resin; a urethane resin; and a copolymer of the above resin; and the like. One kind of resin particles may be used alone, or two or more kinds of resin particles may be used in combination.

From the viewpoint of image density stability, the resin particles are, for example, preferably at least one selected from the group consisting of acrylic resin particles, amino resin particles, and urethane resin particles, more preferably amino resin particles, and still more preferably melamine resin particles.

Since the melamine resin particles have a polarity different from polarity of the inorganic particles, it is considered that the Brazil nut phenomenon works more.

From the viewpoint of image density stability, an average primary particle size of the resin particles is, for example, preferably 100 nm or more and 400 nm or less, and more preferably 150 nm or more and 350 nm or less.

In a case where the average primary particle size of the resin particles is within the above-described range, the difference in particle size with the inorganic particles is appropriate, and the inorganic particles are likely to be unevenly distributed on the lower side of the resin coating layer.

In the present disclosure, the primary particle size of the resin particles is a diameter of a circle having the same area as the primary particle image (so-called equivalent circle diameter), and the average primary particle size of the resin particles is a particle size at which a cumulative percentage from the small diameter side in the number-based distribution of the primary particle diameters is 50%. The primary particle size of the resin particles is determined by performing image analysis on at least 300 resin particles.

A value of a ratio D1/D2 of an average primary particle size D1 of the inorganic particles contained in the resin coating layer to an average primary particle size D2 of the resin particles is, for example, preferably 0.01 or more and 0.15 or less, and more preferably 0.02 or more and 0.10 or less.

In a case where the value of the ratio D1/D2 is within the above-described range, the difference in particle size between the inorganic particles and the resin particles is appropriate, and the inorganic particles are likely to be unevenly distributed on the lower side of the resin coating layer.

A value of a density ratio of the inorganic particles to the resin particles (density of inorganic particles/density of resin particles) is, for example, preferably 1.0 or more and 5.0 or less. In a case where the density ratio is within the above-described range, a difference in sedimentation degree in the liquid is likely to occur in a case where the resin coating layer is formed by the wet manufacturing method, and the inorganic particles are likely to be arranged on the lower side of the resin coating layer.

From the viewpoint of image density stability, a content of the resin particles in the resin coating layer is, for example, preferably lower than the content of the inorganic particles.

From the viewpoint of image density stability, the content of the resin particles contained in the resin coating layer is, for example, preferably 5% by mass or more and 30% by mass or less, more preferably 6% by mass or more and 20% by mass or less, and still more preferably 7% by mass or more and 15% by mass or less with respect to the total mass of the resin coating layer.

### Carbon Black

From the viewpoint of image density stability, for example, the resin coating layer preferably contains carbon black.

From the viewpoint of image density stability, an average primary particle size of the carbon black is, for example, preferably 10 nm or more and 70 nm or less, more preferably 20 nm or more and 60 nm or less, and still more preferably 30 nm or more and 50 nm or less.

A value of a ratio D1/D3 of the average primary particle size D1 of the inorganic particles contained in the resin coating layer to an average primary particle size D3 of the carbon black is, for example, preferably 0.1 or more and 1.0 or less.

In a case where the value of the ratio D1/D3 is within the above-described range, the difference in particle size between the inorganic particles and the carbon black is appropriate, the Brazil nut phenomenon is likely to be exhibited, and the carbon black floats on the upper side of the resin coating layer in a case of forming the resin coating layer by the wet manufacturing method, and as a result, the inorganic particles are likely to be arranged on the lower side of the resin coating layer.

A value of a density ratio of the inorganic particles to the carbon black (density of inorganic particles/density of carbon black) is, for example, preferably 1.0 or more and 5.0 or less. In a case where the density ratio is within the above-described range, a difference in sedimentation degree in the liquid is likely to occur in a case where the resin coating layer is formed by the wet manufacturing method, and the inorganic particles are likely to be arranged on the lower side of the resin coating layer.

From the viewpoint of image density stability, a content of the carbon black in the resin coating layer is, for example, preferably lower than the content of the inorganic particles in the resin coating layer.

From the viewpoint of image density stability, the content of the carbon black in the resin coating layer is, for example, preferably lower than the content of the resin particles in the resin coating layer.

From the viewpoint of image density stability, the content of the carbon black contained in the resin coating layer is, for example, preferably 0.5% by mass or more and 15% by mass or less, more preferably 1% by mass or more and 13% by mass or less, and still more preferably 2% by mass or more and 10% by mass or less with respect to the total mass of the resin coating layer.

From the viewpoint of image density stability, for example, the resin coating layer preferably contains silica particles and melamine resin particles, and more preferably contains silica particles, carbon black, and melamine resin particles.

### Method of Forming Resin Coating Layer

Examples of a method of forming the resin coating layer on the surface of the magnetic particles include a wet manufacturing method and a dry manufacturing method. The wet manufacturing method is a manufacturing method using a solvent that dissolves or disperses the resin constituting the resin coating layer, and for example, the wet manufacturing method is preferred from the viewpoint that the arrangement of the inorganic particles can be controlled by using the sedimentation phenomenon or the Brazil nut phenomenon.

Specifically, examples of the wet manufacturing method include a dipping method of dipping the magnetic particles in a resin solution for forming a resin coating layer; a spray method of spraying the resin solution for forming a resin coating layer to the surface of the magnetic particles; a fluidized bed method of spraying the resin solution for forming a resin coating layer to the magnetic particles that are in a state of being fluidized in a fluidized bed; and a kneader coater method of mixing the magnetic particles with the resin solution for forming a resin coating layer in a kneader coater and removing solvents.

The resin solution for forming the resin coating layer used in the wet manufacturing method is prepared by dissolving or dispersing a resin and other components in a solvent. The solvent is not particularly limited as long as the solvent dissolves or disperses the resin, and for example, aromatic hydrocarbons such as toluene and xylene; ketones such as acetone and methyl ethyl ketone; ethers such as tetrahydrofuran and dioxane; and the like are used.

In Examples described later, the resin coating layer is formed a plurality of times by the wet manufacturing method, but the method of forming the resin coating layer is not limited thereto.

A thickness of the resin coating layer is, for example, preferably 0.5 μm or more and 2.0 μm or less, and more preferably 0.7 μm or more and 1.4 μm or less.

### Magnetic Particles

The magnetic particles are not particularly limited, and known magnetic particles used as a core material of the carrier are applied. Specific examples of the magnetic particles include particles of a magnetic metal such as iron, nickel, and cobalt; particles of a magnetic oxide such as ferrite and magnetite; resin-impregnated magnetic particles in which a porous magnetic powder is impregnated with a resin; and magnetic powder-dispersed resin particles in which a magnetic powder is dispersed in a resin.

As the magnetic particles in the present disclosure, for example, ferrite particles are suitable.

In the present disclosure, for example, it is preferable that the ferrite particles contain at least one compound selected from calcium oxide and strontium oxide. It is presumed that calcium oxide and strontium oxide are likely to be contained in the surface of the ferrite particles, and in a case where a calcium element or a strontium element is present within the surface of the ferrite particles, leakage of charge from the ferrite particles may be suppressed, that may allow the carrier surface to be charged to a high level. Such a carrier inhibits a toner from being charged to a low level in a developing device. As a result, the fogging is further suppressed, and fine line reproducibility is improved (for example, thickening, crushing, or blurring of fine lines is suppressed). The present effect is markedly exhibited in a case where high-concentration and high-density monochromatic images are repeatedly formed at a high speed and then low-density images of the same color are formed.

In the present disclosure, for example, the ferrite particles preferably contain at least one compound selected from calcium oxide and strontium oxide, and the total content of a calcium element and a strontium element is, for example, preferably 0.1% by mass or more and 2.0% by mass or less with respect to the total mass of the ferrite particles. In a case where the total content of the calcium element and the strontium element is 0.1% by mass or more with respect to the entire ferrite particles, charge leakage from the ferrite particles is efficiently suppressed. In a case where the total content of the calcium element and the strontium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the total content of the calcium element and the strontium element with respect to the entire ferrite particles is, for example, preferably 0.1% by mass or more and 2.0% by mass or less, more preferably 0.2% by mass or more and 1.5% by mass or less, and still more preferably 0.5% by mass or more and 1.2% by mass or less.

In the present disclosure, the ferrite particles contain calcium oxide, and a content of the calcium element is, for example, preferably 0.2% by mass or more and 2.0% by mass or less with respect to the total mass of the ferrite particles. In a case where the content of the calcium element is 0.2% by mass or more with respect to the entire ferrite particles, the charge leakage from the ferrite particles is efficiently suppressed. In a case where the total content of the calcium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the calcium element with respect to the entire ferrite particles is, for example, preferably 0.2% by mass or more and 2.0% by mass or less, more preferably 0.5% by mass or more and 1.5% by mass or less, and still more preferably 0.5% by mass or more and 1.0% by mass or less.

In the present disclosure, the ferrite particles contain strontium oxide, and a content of the strontium element is, for example, preferably 0.1% by mass or more and 1.0% by mass or less with respect to the total mass of the ferrite particles. In a case where the content of the strontium element is 0.1% by mass or more with respect to the entire ferrite particles, the charge leakage from the ferrite particles is efficiently suppressed. In a case where the total content of the strontium element is 1.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the strontium element with respect to the entire ferrite particles is, for example, preferably 0.1% by mass or more and 1.0% by mass or less, more preferably 0.4% by mass or more and 1.0% by mass or less, and still more preferably 0.5% by mass or more and 0.8% by mass or less.

The contents of the calcium element and the strontium element contained in the ferrite particles are measured by X-ray fluorescence analysis. The X-ray fluorescence analysis is performed on the ferrite particles by the following method.

Using an X-ray fluorescence spectrometer (XRF1500, manufactured by Shimadzu Corporation) under the conditions of X-ray output: 40 V/70 mA, measurement area: diameter of 10 mm, and measurement time: 15 minutes, qualitative analysis and quantitative analysis are performed. The element to be analyzed is selected based on the element detected by the qualitative analysis. Iron (Fe), manganese (Mn), magnesium (Mg), calcium (Ca), strontium (Sr), oxygen (O), and carbon (C) are generally selected. A mass proportion (%) of each element is calculated with reference to the separately created calibration curve data.

A volume-average particle size of the magnetic particles is, for example, preferably 20 μm or more and 50 μm or less, more preferably 25 μm or more and 45 μm or less, and still more preferably 30 μm or more and 40 μm or less.

As for a magnetic force of the magnetic particles, a saturation magnetization of the magnetic particles in a magnetic field of 3,000 Oe is 50 emu/g or more, for example, preferably 60 emu/g or more. The saturation magnetization is measured using a vibrating sample magnetometer VSMP10-15 (TOET INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and coercive force are obtained from the data of the curve.

An electrical volume resistance (volume resistivity) of the magnetic particles is 1×10⁵ Ω·cm or more and 1×10⁹ Ω·cm or less, for example, preferably 1×10⁷ Ω·cm or more and 1×10⁹ Ω·cm or less.

The electrical volume resistance (Ω·cm) of the magnetic particles is measured as follows. A measurement target is placed flat on the surface of a circular jig on which a 20 cm² electrode plate is disposed, such that the measurement target has a thickness of approximately 1 mm or more and 3 mm or less and forms a layer. The above-described 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 103.8 V/cm is generated, and the current value (A) flowing at this time is read. The volume resistivity is measured in an environment at a temperature of 20° C. and a humidity of 50% RH. An expression for calculating the electrical volume resistance (Ω·cm) of the measurement target is as follows.

$$R = E \times 20 / ( I - {I}_{0} ) / L$$

In the above expression, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient of 20 represents an area (cm²) of the electrode plate.

### Characteristics of Carrier

A volume-average particle size of the carrier is, for example, preferably 20 μm or more and 52 μm or less, more preferably 25 μm or more and 47 μm or less, and still more preferably m or more and 42 μm or less.

A volume-average particle size of the carrier is a particle size at which a cumulative percentage from the small diameter side in the volume-based particle size distribution is 50%. The particle size distribution of the carrier is measured with a laser diffraction/scattering type particle size distribution analyzer.

In a case of analyzing the carrier contained in the developer, examples of a method of separating the carrier from the developer include a method of removing the toner from the developer by air blowing using any mesh.

As for a magnetic force of the carrier, a saturation magnetization of the carrier in a magnetic field of 1,000 Oe is 40 emu/g or more, for example, preferably 50 emu/g or more. The measurement of the saturation magnetization described above is performed by sweeping up to a maximum of 1,000 Oe in the same manner as the measurement of the saturation magnetization of the magnetic particles.

A volume electrical resistance (25° C.) of the carrier is 1×10⁷ Ω·cm or more and 1×10¹⁵ Ω·cm or less, for example, preferably 1×10⁸ Ω·cm or more and 1×10¹⁴ Ω·cm or less and more preferably 1×10⁸ Ω·cm or more and 1×10¹³ Ω·cm or less. The measurement of the volume electrical resistance of the carrier is performed in the same manner as the measurement of the volume electrical resistance of the magnetic particles.

An exposed proportion of the magnetic particles on the surface of the carrier is, for example, preferably 2% or more and 20% or less, more preferably 3% or more and 15% or less, and still more preferably 4% or more and 12% or less.

The exposed proportion of the magnetic particles on the surface of the carrier is determined by X-ray photoelectron spectroscopy (XPS) from the following method.

A target carrier and magnetic particles obtained by removing the resin coating layer from the target carrier are prepared. Examples of a method of removing the resin coating layer from the carrier include a method of removing the resin coating layer by dissolving resin components with an organic solvent, and a method of removing the resin coating layer by heating the carrier to approximately 800° C. to eliminate the resin components. The carrier and the magnetic particles excluding the resin coating layer are each used as a measurement sample, Fe (atomic %) is quantified by XPS, and (Fe of carrier)÷(Fe of magnetic particles)×100 is calculated to obtain the exposed proportion (%) of the magnetic particles.

The exposed proportion of the magnetic particles on the surface of the carrier can be controlled by the amount of the resin used for forming the resin coating layer, and as the amount of the resin relative to the amount of the magnetic particles is larger, the exposed proportion is smaller.

### Electrostatic Charge Image Developing Toner

### Dynamic Viscoelasticity of Toner Particles

Regarding the toner particles contained in the toner according to the present disclosure, in a dynamic viscoelasticity measurement of the toner particles in a case where a temperature is raised from 30° C. to 120° C., the minimal value tan δ(min) of the loss tangent is present at a temperature of 50° C. or higher and 80° C. or lower and is 0.50 or more and 1.00 or less.

From the viewpoint of image density stability, the minimal value tan δ(min) of the loss tangent is 0.50 or more and 1.00 or less, for example, preferably 0.60 or more and 0.96 or less, and more preferably 0.70 or more and 0.90 or less.

In the toner particles contained in the toner according to the present disclosure, from the viewpoint of more excellent image density stability, a value of a ratio tan δ(90)/tan δ(min) of a loss tangent tan δ(90) at a temperature of 90° C. to the minimal value tan δ(min) of the loss tangent is, for example, preferably 2.5 or less, more preferably 2.2 or less, and still more preferably 2.0 or less.

The dynamic viscoelasticity of the toner particles is measured as follows.

The toner particles are molded into a tablet form at room temperature (25° C.) using a press molding machine, and the molded product is used as a sample. Since the loss tangent tan δ of the toner particles is not affected by the external additive, the toner may be used as a sample.

The sample is placed on a measurement device and left at a temperature of 120° C. for 20 minutes. Next, the sample is cooled to a temperature of 60° C., maintained at the temperature of 60° C. for 1 hour, and cooled to room temperature, and dynamic viscoelasticity is measured under the following measurement conditions to measure a storage elastic modulus and a loss elastic modulus. The loss tangent tan δ is obtained from the storage elastic modulus and the loss elastic modulus, and a graph showing a relationship between the measurement temperature and the loss tangent tan δ is drawn.
Measurement device: rheometer ARES (manufactured by TA Instruments)
Fixture: 8 mm parallel plates
Gap: adjusted to 3 mm
Frequency: 6.28 rad/s
Temperature rising conditions: start temperature=30° C., end temperature=120° C., temperature rising rate=2° C./min

Examples of a method of controlling the minimal value tan δ(min) of the loss tangent and the ratio tan δ(90)/tan δ(min) to be in the above-described ranges include the following (1) and (2).

(1) crosslinked resin particles are internally added to the toner particles; as the crosslinked resin particles, for example, resin particles having an appropriate glass transition temperature are preferable.

(2) the amount of metal ions contained in the toner particles is adjusted to control a degree of crosslinking of the binder resin by the metal ions; as the metal ion, for example, at least one kind metal ion selected from the group consisting of an Al ion, an Mg ion, and a Ca ion is preferable.

### Toner Particles

The toner particles contain at least a binder resin, and may further contain a colorant, a release agent, internally-added crosslinked resin particles, or various kinds of additives. From the viewpoint of controlling the dynamic viscoelasticity, for example, it is preferable that the toner particles contain crosslinked resin particles.

### Binder Resin

For example, the binder resin preferably includes an amorphous polyester resin, and preferably further includes a crystalline resin. As the crystalline resin, for example, a crystalline polyester resin is preferable.

The “crystalline” resin refers to have a clear endothermic peak instead of showing a stepwise change in endothermic amount, in differential scanning calorimetry (DSC). Specifically, a half width of the endothermic peak in a case where the temperature is raised at a rate of 10° C./min is within 10° C.

The “amorphous” resin indicates that the half-width is higher than 10° C., a stepwise change in endothermic amount is shown, or a clear endothermic peak is not recognized.

For example, it is preferable that the amorphous polyester resin includes an amorphous polyester resin (S) having at least one of a constitutional unit represented by Formula (A) or a constitutional unit represented by Formula (B).

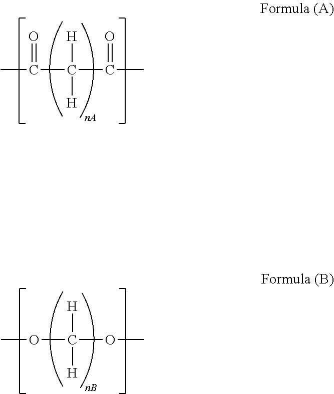

nA in Formula (A) is an integer of 2 or more and 12 or less.

nB in Formula (B) is an integer of 2 or more and 12 or less.

nA in Formula (A) is, for example, preferably an integer of 3 or more and 11 or less, more preferably an integer of 3 or more and 10 or less, and still more preferably an integer of 4 or more and 10 or less.

nB in Formula (B) is, for example, preferably an integer of 3 or more and 11 or less, more preferably an integer of 3 or more and 10 or less, and still more preferably an integer of 4 or more and 10 or less.

From the viewpoint of more excellent image density stability, the total proportion of the constitutional unit represented by Formula (A) and the constitutional unit represented by Formula (B) in all constitutional units constituting the amorphous polyester resin contained in the toner particles is, for example, preferably 0.5% by mole or more and 10.0% by mole or less, more preferably 1.5% by mole or more and 8.0% by mole or less, and still more preferably 2.5% by mole or more and 6.0% by mole or less.

From the viewpoint of more excellent image density stability, a proportion of the constitutional unit represented by Formula (A) in all carboxylic acid units constituting the amorphous polyester resin contained in the toner particles is, for example, preferably 2.0% by mole or more and 15.0% by mole or less, more preferably 3.0% by mole or more and 10.0% by mole or less, and still more preferably 3.2% by mole or more and 9.5% by mole or less.

The proportion of the constitutional unit represented by Formula (A) and the proportion of the constitutional unit represented by Formula (B) in all constitutional units constituting the amorphous polyester resin contained in the toner particles are determined by the following measurement method.

The toner is dissolved in a solvent in which the binder resin is soluble, such as tetrahydrofuran, insoluble components are removed, and soluble components are dried. The dried matter is dissolved in a solvent in which the amorphous polyester resin is soluble and the crystalline resin is insoluble, insoluble components are removed, and soluble components are dried. The differential scanning calorimetry is performed to confirm that the dried matter does not have an endothermic peak derived from the crystalline resin. After the check, NMR is performed to obtain a ¹H-NMR spectrum. The proportion of the constitutional unit represented by Formula (A) and the proportion of the constitutional unit represented by Formula (B) are obtained from a chemical shift and an integral value ratio analyzed by the ¹H-NMR spectrum.

From the viewpoint of more excellent image density stability, for example, the amorphous polyester resin (S) preferably has a constitutional unit derived from an aromatic polyvalent carboxylic acid and/or a constitutional unit derived from an aromatic polyhydric alcohol, in addition to the constitutional unit represented by Formula (A) and the constitutional unit represented by Formula (B).

From the viewpoint of more excellent image density stability, the amorphous polyester resin (S) is, for example, preferably a resin having at least the constitutional unit represented by Formula (A), a constitutional unit derived from an aromatic polyvalent carboxylic acid, and a constitutional unit derived from an aromatic polyhydric alcohol; and more preferably a resin having the constitutional unit represented by Formula (A), the constitutional unit represented by Formula (B), a constitutional unit derived from terephthalic acid, and a constitutional unit derived from an aromatic polyhydric alcohol.

From the viewpoint of easy availability and low cost, the amorphous polyester resin (S) is, for example, preferably a resin having only the constitutional unit represented by Formula (A) among the constitutional unit represented by Formula (A) and the constitutional unit represented by Formula (B).

Examples of the aliphatic dicarboxylic acid applied to the constitutional unit represented by Formula (A) include succinic acid, glutaric acid, adipic acid, pimelic acid, suberic acid, sebacic acid, azelaic acid, dodecanedioic acid, and anhydrides thereof. One kind thereof may be used alone, or two or more kinds thereof may be used in combination.

Examples of the aromatic polyvalent carboxylic acid include terephthalic acid, isophthalic acid, orthophthalic acid, naphthalenedicarboxylic acid, anhydrides thereof, and lower (for example, 1 to 5 carbon atoms) alkyl esters thereof.

A carboxylic acid having a valency of 3 or more, that forms a crosslinked structure or a branched structure, may be used in combination with the dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the aliphatic diol applied to the constitutional unit represented by Formula (B) include ethylene glycol, butanediol, pentanediol, hexanediol, heptanediol, octanediol, nonanediol, decanediol, and undecane diol. One kind thereof may be used alone, or two or more kinds thereof may be used in combination.

Examples of the aromatic polyhydric alcohol include an ethylene oxide adduct of bisphenol A and a propylene oxide adduct of bisphenol A.

A polyhydric alcohol having a valency of 3 or more, that forms a crosslinked structure or a branched structure, may be used in combination with the diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

A glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). Specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). In the GPC, HLC-8120GPC (Tosoh Corporation) is used as a measurement device, TSKgel Super HM-M (diameter: 15 cm, Tosoh Corporation) is used as a column, and tetrahydrofuran is used as a solvent. The weight-average molecular weight and the number-average molecular weight are calculated using a molecular weight calibration curve plotted using a monodisperse polystyrene standard sample.

The amorphous polyester resin is, for example, preferably a combination of two or more amorphous polyesters having different molecular weights; and for example, a combination of a low-molecular-weight amorphous polyester resin and a high-molecular-weight amorphous polyester resin is preferable. A weight-average molecular weight of the low-molecular-weight amorphous polyester resin is, for example, preferably 9,000 or more and 20,000 or less. A weight-average molecular weight of the high-molecular-weight amorphous polyester resin is, for example, preferably 25,000 or more and 70,000 or less. An acid value of the low-molecular-weight amorphous polyester resin is, for example, preferably 13 mgKOH/g or more and 20 mgKOH/g or less. An acid value of the high-molecular-weight amorphous polyester resin is, for example, preferably 10 mgKOH/g or more and 15 mgKOH/g or less.

For example, the binder resin of the toner particles preferably further includes a crystalline resin in addition to the amorphous polyester resin.

Examples of the crystalline resin include a crystalline polyester resin and a crystalline vinyl resin (for example, a polyalkylene resin, a long-chain alkyl (meth)acrylate resin, and the like). As the crystalline resin, for example, a crystalline polyester resin is preferable from the viewpoint of low-temperature fixability of the toner.

Since the crystalline polyester resin easily forms a crystal structure, the crystalline polyester resin is, for example, preferably a polycondensate formed of a monomer having linear chain, compared to a monomer having an aromatic ring.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

A carboxylic acid having a valency of 3 or more, that forms a crosslinked structure or a branched structure, may be used in combination with the dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

A dicarboxylic acid having a sulfonic acid group or a dicarboxylic acid having an ethylenically double bond may be used in combination with the dicarboxylic acid.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

An alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

A proportion of the aliphatic diol to the polyhydric alcohol is, for example, preferably 80% by mole or more, and more preferably 90% by mole or more.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

A weight-average molecular weight (Mw) of the crystalline polyester resin is, for example, preferably 6,000 or more and 35,000 or less.

The content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

From the viewpoint of low-temperature fixability of the toner, a proportion of the crystalline resin in the binder resin is, for example, preferably 2% by mass or more and 40% by mass or less, more preferably 5% by mass or more and 35% by mass or less, still more preferably 10% by mass or more and 30% by mass or less, and particularly preferably 15% by mass or more and 30% by mass or less.

### Internally-Added Crosslinked Resin Particles

The internally-added crosslinked resin particles are resin particles contained in the toner particles, and refers to resin particles having a bridged structure. The internally-added crosslinked resin particles are, for example, particles that are present in the toner particles in a state of being incompatible with the binder resin.

Examples of the internally-added crosslinked resin particles include crosslinked resin particles crosslinked by an ionic bond and crosslinked resin particles crosslinked by a covalent bond. For example, crosslinked resin particles crosslinked by a covalent bond are preferable as the internally-added crosslinked resin particles.

Examples of the type of the resin constituting the internally-added crosslinked resin particles include a polyolefin-based resin (such as polyethylene and polypropylene), a styrene-based resin (such as polystyrene and α-polymethylstyrene), a (meth)acrylic resin (such as polymethyl methacrylate and polyacrylonitrile), an epoxy resin, a polyurethane resin, a polyurea resin, a polycarbonate resin, a polyether resin, a polyester resin, and copolymer resins of these compounds. One kind of each of these resins may be used alone, or two or more kinds of these resins may be used in combination.

As the resin constituting the internally-added crosslinked resin particles, for example, a styrene acrylic copolymer is preferable.

A proportion of a styrene acrylic copolymer in the internally-added crosslinked resin particles is, for example, preferably 80% by mass or more, more preferably 90% by mass or more, and still more preferably substantially 100% by mass.

The total of the styrene-based monomer and the (meth)acrylic monomer in the monomers constituting the styrene acrylic copolymer is, for example, preferably 80% by mass or more, more preferably 90% by mass or more, and still more preferably 95% by mass or more. The remainder is a crosslinking agent described later.

Examples of the styrene-based monomer constituting the styrene acrylic copolymer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the monomers, for example, styrene or α-methylstyrene is preferable.

Examples of the (meth)acrylic monomer constituting the styrene acrylic copolymer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among the monomers, for example, n-butyl (meth)acrylate or 2-carboxyethyl (meth)acrylate is preferable.

Examples of a crosslinking agent for crosslinking the resin constituting the internally-added crosslinked resin particles include aromatic polyvalent vinyl compounds such as divinylbenzene and divinylnaphthalene; polyvalent vinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic carboxylic acid compounds, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy,1,3-diacryloxypropane; and polyvalent vinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of the crosslinking agent may be used alone, or two or more kinds of colorants may be used in combination.

From the viewpoint of controlling a crosslinking density and elasticity of the internally-added crosslinked resin particles, as the crosslinking agent, for example, a bifunctional alkyl acrylate having an alkylene chain having 6 or more carbon atoms is preferable. That is, for example, it is preferable that the internally-added crosslinked resin particles have a bifunctional alkyl acrylate as a constitutional unit, and the number of carbon atoms in the alkylene chain of the bifunctional alkyl acrylate is 6 or more.

From the viewpoint of adjusting the crosslinking density to an appropriate range, the number of carbon atoms in the alkylene chain of the bifunctional alkyl acrylate is, for example, preferably 6 or more, more preferably 6 or more and 12 or less, and still more preferably 8 or more and 12 or less. Examples of the bifunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate. Among the above, for example, 1,10-decanediol diacrylate or 1,10-decanediol dimethacrylate is preferable.

Examples of the crosslinking agent also include 2-carboxyethyl acrylate. As the crosslinking agent, for example, at least one of a bifunctional alkyl acrylate or 2-carboxyethyl acrylate is preferably used.

In a case where the internally-added crosslinked resin particles are polymer particles of a composition containing a styrene-based monomer, a (meth)acrylic monomer, and a crosslinking agent, the amount of the crosslinking agent contained in the composition can be adjusted to control the elasticity of the internally-added crosslinked resin particles. A content of the crosslinking agent with respect to 100 parts by mass of the total amount of the styrene-based monomer, the (meth)acrylic monomer, and the crosslinking agent is, for example, preferably 0.3 parts by mass or more and 5.0 parts by mass or less, more preferably 0.5 parts by mass or more and 3.0 parts by mass or less, and still more preferably 0.8 parts by mass or more and 2.5 parts by mass or less.

From the viewpoint of controlling the loss tangent tan δ of the toner particles, a glass transition temperature Tg of the internally-added crosslinked resin particles is, for example, preferably 0° C. or higher and 40° C. or lower, and more preferably 5° C. or higher and 35° C. or lower.

The glass transition temperature Tg of the internally-added crosslinked resin particles is determined from a DSC curve obtained by the differential scanning calorimetry (DSC). Specifically, the glass transition temperature Tg of the internally-added crosslinked resin particles is determined by “extrapolated glass transition onset temperature” described in the method for determining a glass transition temperature in JIS K 7121-1987, “Testing methods for transition temperatures of plastics”.

The internally-added crosslinked resin particles are obtained by dissolving the toner in a solvent in which the binder resin is soluble, such as tetrahydrofuran, collecting the insoluble matter, and drying the insoluble matter.

From the viewpoint of controlling the loss tangent tan δ of the toner particles, an average dispersion size of the internally-added crosslinked resin particles is, for example, preferably 50 nm or more and 300 nm or less, more preferably 80 nm or more and 300 nm or less, and still more preferably 100 nm or more and 250 nm or less.

A method of measuring the average dispersion size of the internally-added crosslinked resin particles is as follows.

The toner particles or the toner is mixed with and embedded in an epoxy resin, and the epoxy resin is solidified. The solidified product is cut with an ultramicrotome device to produce a thin sample having a thickness of 80 nm or more and 130 nm or less. The thin sample is dyed with ruthenium tetroxide in a desiccator at a temperature of 30° C. for 3 hours. An SEM image of the dyed thin sample is obtained by a super high-resolution field emission type scanning electron microscope (FE-SEM). Since the release agent, the styrene acrylic resin, and the polyester resin are likely to be dyed by the ruthenium tetroxide in this order, each component is identified by a shade caused by the degree of dyeing. In a case where it is difficult to distinguish the light and shade due to the condition of the sample or the like, the staining time is adjusted. In the cross section of the toner particles, the domain of the colorant is smaller than the domain of the release agent and the domain of the resin particles, so that the domains are distinguished by the size.

In the SEM image, 30 toner cross sections having a maximum length of 85% or more of the volume-average particle size of the toner particles are selected, and a total of 100 dyed internally-added crosslinked resin particles (that is, domains of the styrene acrylic resin) are observed. The maximum length of each of the internally-added crosslinked resin particles is measured, the maximum lengths are averaged, and the average is defined as the average dispersion size.

The adjustment of the average dispersion size of the internally-added crosslinked resin particles can be controlled by adjusting a volume-average particle size of the internally-added crosslinked resin particles contained in the internally-added crosslinked resin particle dispersion used in production of the toner particles by the aggregation and coalescence method; preparing a plurality of internally-added crosslinked resin particle dispersions with different volume-average particle sizes and using the resin particle dispersions in combination; or the like.

From the viewpoint of controlling the loss tangent tan δ of the toner particles, a content of the internally-added crosslinked resin particles is, for example, preferably 2% by mass or more and 20% by mass or less, and more preferably 5% by mass or more and 15% by mass or less with respect to the entire toner.

### Method for Producing Internally-Added Crosslinked Resin Particles

Examples of a method for producing the internally-added crosslinked resin particles include a known method such as an emulsion polymerization method, a melt-kneading method using a Banbury mixer or a kneader, a suspension polymerization method, and a spray drying method. As the method for producing the internally-added crosslinked resin particles, for example, an emulsion polymerization method is preferable from the viewpoint of causing units derived from the styrene-based monomer to be unevenly distributed on the surface of the particles.

For example, it is preferable that the internally-added crosslinked resin particles are obtained by emulsion polymerization using the styrene-based monomer and the (meth)acrylic monomer in the presence of the crosslinking agent. The emulsion polymerization is, for example, preferably carried out in a plurality of times. Hereinafter, the method for producing the internally-added crosslinked resin particles by the emulsion polymerization method will be described.

For example, it is preferable that the method for producing the internally-added crosslinked resin particles includes a step (emulsion preparation step) of obtaining an emulsion containing a monomer, a crosslinking agent, a surfactant, and water; a step (first emulsion polymerization step) of adding a polymerization initiator to the emulsion and then heating to polymerize the monomer; and a step (second emulsion polymerization step) of adding an emulsion containing a monomer and a crosslinking agent to the reaction solution after the first emulsion polymerization step, and then heating to polymerize the monomers.

In the second emulsion polymerization step, from the viewpoint of adjusting a formulation of the surface of the particles, emulsions having different ratios of the styrene-based monomer to the (meth)acrylic monomer may be added a plurality of times.

### Emulsion Preparation Step

The emulsion preparation step is a step of obtaining an emulsion containing a monomer, a crosslinking agent, a surfactant, and water. For example, the monomer, the crosslinking agent, the surfactant, and water are emulsified with an emulsifying machine. Examples of the emulsifying machine include a rotary stirrer equipped with a propeller type, anchor type, paddle type, or turbine type stirring blade, a stationary mixer such as a static mixer, and a rotor and stator type emulsifying machine such as a homogenizer or Clare mix, a mill type emulsifying machine having grinding function, a high-pressure emulsifying machine such as a Munton Gorlin-type pressure emulsifying machine, a high-pressure nozzle type emulsifying machine that causes cavitation under high pressure, a high-pressure impact-type emulsifying machine, such as a microfluidizer, that generates shearing force by causing collision of liquids under high pressure, an ultrasonic emulsifying machine that causes cavitation by using ultrasonic waves, and a membrane emulsifying machine that performs emulsification through pores.

As the monomer, for example, the styrene-based monomer and the (meth)acrylic monomer are preferable.

As the crosslinking agent, for example, the above-described crosslinking agent is preferable.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. The nonionic surfactant may be used in combination with an anionic surfactant or a cationic surfactant. Among the surfactants, for example, an anionic surfactant is preferable. One kind of surfactant may be used alone, or two or more kinds of surfactants may be used in combination.

The emulsion may contain a chain transfer agent. As the chain transfer agent, for example, a compound having a thiol component is preferable. Specifically, for example, alkyl mercaptans such as hexyl mercaptan, heptyl mercaptan, octyl mercaptan, nonyl mercaptan, decyl mercaptan, and dodecyl mercaptan are preferable.

A mass ratio of the styrene-based monomer to the (meth)acrylic monomer in the emulsion (styrene-based monomer/(meth)acrylic monomer) is, for example, preferably 0.2 or more and 1.1 or less.

A content of the crosslinking agent with respect to the entire emulsion is, for example, preferably 0.5% by mass or more and 3% by mass or less.

### First Emulsion Polymerization Step

The first emulsion polymerization step is a step of adding a polymerization initiator to the emulsion and then heating to polymerize the monomer. As the polymerization initiator, for example, it is preferable to use ammonium persulfate.

In the first emulsion polymerization step, for example, it is preferable to stir the emulsion (reaction solution) containing the polymerization initiator with a stirrer. Examples of the stirrer include a rotary stirrer equipped with a propeller type, anchor type, paddle type, or turbine type stirring blade.

### Second Emulsion Polymerization Step

The second emulsification polymerization step is a step of adding an emulsion containing a monomer to the reaction solution obtained after the first emulsification polymerization step, and then heating the reaction solution to polymerize the monomer. The emulsion containing the monomer is obtained, for example, by emulsifying a monomer, a surfactant, and water with an emulsifying machine.

In the second emulsion polymerization step, from the viewpoint of adjusting a formulation of the surface of the particles, emulsions having different ratios of the styrene-based monomer to the (meth)acrylic monomer may be added a plurality of times.

In the second emulsion polymerization step, for example, it is preferable to stir the reaction solution in the same manner as in the first emulsion polymerization step.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral-petroleum-based wax such as montan wax; and ester-based wax such as fatty acid esters and montanic acid esters. One kind of the release agent may be used alone, or two or more kinds of colorants may be used in combination.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, a charge control agent, and inorganic powder. The additives are incorporated into the toner particles as internal additives.

### Characteristics of Toner Particles

The toner particles may be toner particles that have a single-layer structure or toner particles having a so-called core/shell structure that is configured with a core portion (core particle) and a coating layer (shell layer) coating the core portion.

The toner particles having a core/shell structure may, for example, be configured with a core portion that is configured with a binder resin, internally-added crosslinked resin particles, and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The volume-average particle size of the toner particles is measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

In the volume-based particle size distribution, a particle size at which the cumulative percentage is 50% from the small size side is defined as the volume-average particle size.

The average circularity of the toner particles is, for example, preferably 0.90 or more and 1.00 or less, and more preferably 0.92 or more and 0.98 or less.

The average circularity of the toner particles is (peripheral length of circle having the same projection area as the particle image)/(peripheral length of the particle projection image). The particle projection image is analyzed using a flow-type particle image analyzer (FPIA-3000, Sysmex Corporation). The number of sampled toner particles is 3,500. In a case where a toner contains external additives, the toner is dispersed in water containing a surfactant, and then the dispersion is treated with ultrasonic waves such that the external additives are removed to obtain the toner particles.

For example, it is preferable that the toner particles contain at least one metal ion selected from the group consisting of an Al ion, an Mg ion, and a Ca ion. A ratio AV1/M1 of an acid value AV1 of the binder resin to a total amount M1 of the metal ions is, for example, preferably 1.0×10³ or more and 4.0×10³ or less, more preferably 1.5×10³ or more and 3.8×10³ or less, and still more preferably 2.0×10³ or more and 3.5×10³ or less. By setting the ratio AV1/M1 to within the above-described range, an appropriate crosslinking structure is imparted to the binder resin, and the loss tangent tan δ of the toner particles is easily controlled.

The above-described amount of the metal ions with respect to the toner particles is, for example, preferably 0.0015% by mass or more and 0.0150% by mass or less, and more preferably 0.0020% by mass or more and 0.010% by mass or less.

Examples of a supply source (compound contained in the toner particles as an additive) of the at least one metal ion selected from the group consisting of an Al ion, an Mg ion, and a Ca ion include a metal salt, an inorganic metal salt polymer, and a metal complex. These compounds are used, for example, as an aggregating agent in a case where the toner particles are manufactured by the aggregation and coalescence method.

Examples of the metal salt include aluminum sulfate, aluminum chloride, magnesium chloride, magnesium sulfate, calcium chloride, and calcium sulfate.

Examples of the inorganic metal salt polymer include polyaluminum chloride, polyaluminum hydroxide, and calcium polysulfide.

Examples of the metal complex include aluminum salts, magnesium salts, and calcium salts of a known chelating agent such as ethylenediaminetetraacetic acid, propanediaminetetraacetic acid, nitrilotriacetic acid, triethylenetetraminehexaacetic acid, and diethylenetriaminepentaacetic acid.

These supply sources of the metal ions may be added as a simple additive, not for the purpose of the aggregating agent.

As the metal ion, for example, an Al ion is preferable. As the supply source of the metal ions, for example, an aluminum salt (for example, aluminum sulfate, aluminum chloride, and the like) or an aluminum salt polymer (for example, polyaluminum chloride, polyaluminum hydroxide, and the like) is preferable. As the supply source of the metal ions, for example, an inorganic metal salt polymer is preferable; and as the supply source of the metal ions, an aluminum salt polymer (for example, polyaluminum chloride, polyaluminum hydroxide, or the like) is particularly preferable.

The amount of the metal ions can be quantified by a fluorescent X-ray intensity of the toner particles. The resin and the supply source of the metal ions are mixed to obtain a resin mixture in which the amount of the metal ions is known. 200 mg of the resin mixture is molded into a tablet form having a diameter of 13 mm to obtain a sample. The mass of the sample is weighed, the fluorescence X-ray intensity of the sample is measured, and the peak intensity is obtained. A calibration curve is created from the measurement results of the sample in which the amount of the metal ions is changed. Target toner particles are also measured for the fluorescence X-ray intensity, and the amount of the metal ions is quantified from the calibration curve.

Examples of the method of adjusting the amount of the metal ions include the following (1) and (2).

(1) the amount of the supply source of the metal ions to be added is adjusted.

(2) in a case where the toner particles are produced by the aggregation and coalescence method, an aggregating agent (for example, a metal salt or a metal salt polymer) is added as a supply source of a metal ion, a chelating agent (for example, ethylenediamine tetraacetic acid, diethylenetriamine pentaacetic acid, nitrilotriacetic acid, or the like) is added thereto in an appropriate amount to form a metal complex, and the metal complex is removed in a washing step of the toner particles.

The acid value of the binder resin is measured based on JIS K 0070-1992 “Test Methods for Acid Value, Saponification Value, Ester Value, Iodine Value, Hydroxyl Value, and Unsaponifiable Value of Chemical Products”.

The binder resin is obtained by dissolving the toner in a solvent in which the binder resin is soluble, such as tetrahydrofuran, removing the insoluble matter, and drying the soluble matter.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, MgSO₄ and SrTiO₃.

The surface of the inorganic particles as an external additive may have undergone, for example, a hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. One kind thereof may be used alone, or two or more kinds thereof may be used in combination.

The amount of the hydrophobizing agent is, for example, preferably 1 part by mass or more and 30 parts by mass or less with respect to 100 parts by mass of the inorganic particles.

Examples of the external additive also include resin particles (resin particles such as polystyrene, polymethylmethacrylate, and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 5% by mass or less.

### Manufacturing Method of Toner

The toner is obtained by manufacturing toner particles and then externally adding external additives to the toner particles. The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

Hereinafter, an exemplary embodiment of the aggregation and coalescence method will be described.

An exemplary embodiment of the aggregation and coalescence method includes: a step of mixing an amorphous polyester resin particle dispersion, a crystalline resin particle dispersion, an internally-added crosslinked resin particle dispersion, a release agent particle dispersion, and a colorant dispersion are mixed with each other to aggregate each particle and the colorant in the obtained dispersion, thereby forming first aggregated particles (first aggregated particle-forming step); a step of mixing the dispersion in which the first aggregated particles are dispersed with an amorphous polyester resin particle dispersion to aggregate the amorphous polyester resin particles on a surface of the first aggregated particles, thereby forming second aggregated particles (second aggregated particle-forming step); and a step of heating the dispersion in which the second aggregated particles are dispersed to coalesce the second aggregated particles, thereby forming toner particles (coalescence step).

Hereinafter, each of the steps will be described in detail.

### Dispersion Preparation Step

Each dispersion to be used in the aggregation and coalescence method is prepared. An amorphous polyester resin particle dispersion, a crystalline resin particle dispersion, an internally-added crosslinked resin particle dispersion, a release agent particle dispersion, and a colorant dispersion are prepared.

The resin particle dispersion is prepared, for example, by dispersing the resin particles in a dispersion medium by using a surfactant.

Examples of the dispersion medium used for the resin particle dispersion include an aqueous medium. Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among the above, for example, an anionic surfactant or a cationic surfactant is preferable. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the dispersion medium by using a transitional phase-transfer emulsification method. The transitional phase-transfer emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes phase transition from W/O to O/W and is dispersed in the aqueous medium in a particulate form.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less. The volume-average particle size of the resin particles is measured using a laser diffraction type particle size distribution analyzer (for example, LA-700, HORIBA, Ltd.). In the volume-based particle size distribution, a particle size at which the cumulative percentage is 50% from the small particle side is defined as the volume-average particle size. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

The internally-added crosslinked resin particle dispersion, the release agent particle dispersion, and the colorant dispersion are also prepared in the same manner as the resin particle dispersion. The dispersion medium, the dispersion method, the content of the particles, and the volume-average particle size of the particles in the resin particle dispersion are used in the same manner in the internally-added crosslinked resin particle dispersion, the release agent particle dispersion, and the colorant dispersion.

### First Aggregated Particle-Forming Step

The amorphous polyester resin particle dispersion, the crystalline resin particle dispersion, the internally-added crosslinked resin particle dispersion, the release agent particle dispersion, and the colorant dispersion are mixed with each other. In the mixed dispersion, each particle and the colorant are aggregated to form first aggregated particles.

An aggregating agent is added to the mixed dispersion obtained by mixing each dispersion, a pH of the mixed dispersion is adjusted to an acidic condition (for example, pH of 2 or more and 5 or less), a dispersion stabilizer is added thereto as necessary, and the dispersion is maintained at a temperature of 20° C. or higher and 50° C. or lower to form the first aggregated particles.

In the first aggregated particle-forming step, for example, in a state where the mixed dispersion is agitated with a rotary shearing homogenizer, the aggregating agent may be added thereto at room temperature (for example, 25° C.), the pH of the mixed dispersion may be adjusted such that the dispersion is acidic (for example, pH of 2 or more and 5 or less), a dispersion stabilizer may be added to the dispersion as necessary, and then the dispersion may be heated.

Examples of the aggregating agent include a surfactant having polarity opposite to the polarity of the surfactant contained in the mixed dispersion, an inorganic metal salt, and a metal complex having a valency of 2 or more. In a case where a metal complex is used as the aggregating agent, the amount of the surfactant used is reduced, and the charging characteristics are improved.

An additive that forms a complex or a bond similar to the complex with a metal ion of the aggregating agent may be used as necessary. As the additive, for example, a chelating agent is preferable.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

An amount of the chelating agent added with respect to 100 parts by mass of the resin particles is, for example, preferably 0.01 parts by mass or more and 5.0 parts by mass or less, and more preferably 0.1 parts by mass or more and less than 3.0 parts by mass.

### Second Aggregated Particle-Forming Step

The dispersion of the first aggregated particles and an amorphous polyester resin particle dispersion are mixed with each other.

The amorphous polyester resin in the second aggregated particle-forming step may be of the same kind as or different kind from the amorphous polyester resin in the first aggregated particle-forming step.

The amorphous polyester resin particles are aggregated on the surface of the first aggregated particles in the dispersion containing the first aggregated particles and the amorphous polyester resin particles. By adding the release agent particle dispersion, the amorphous polyester resin particles and the release agent particles may be aggregated on the surface of the first aggregated particles.

In the second aggregated particle-forming step, for example, in a case where the first aggregated particles reach an intended particle size, the amorphous polyester resin particle dispersion is added to the first aggregated particle dispersion, and the dispersion is heated at a temperature equal to or lower than a glass transition temperature of the amorphous polyester resin. Thereafter, by setting the pH of the dispersion in a range of, for example, about 6.5 or more and 8.5 or less, the progress of aggregation is stopped.

### Coalescence Step

The second aggregated particle dispersion containing the second aggregated particles is heated such that the second aggregated particles coalesce. A heating temperature is, for example, a temperature equal to or higher than the glass transition temperature of the amorphous polyester resin (for example, a temperature higher than the glass transition temperature by 10° C. to 30° C.).

The toner particles are obtained through the above steps.

The second aggregated particle-forming step may not be performed, and the first aggregated particles may be coalesced to form the toner particles. The second aggregated particle-forming step may be repeated a plurality of times. In the second aggregated particle-forming step, the crystalline resin particle dispersion, the internally-added crosslinked resin particle dispersion, and/or the release agent particle dispersion may be used.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

For example, by adding an external additive to the obtained dry toner particles and mixing the external additive and the toner particles together, the toner is manufactured. The mixing may be performed, for example, using a V blender, a Henschel mixer, a Lödige mixer, or the like. Coarse particles of the toner may be removed as necessary by using a vibratory sieving machine, a pneumatic sieving machine, or the like.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, well-known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case where the image forming apparatus according to the present exemplary embodiment is the intermediate transfer-type apparatus, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawings, main parts will be described, and others will not be described.

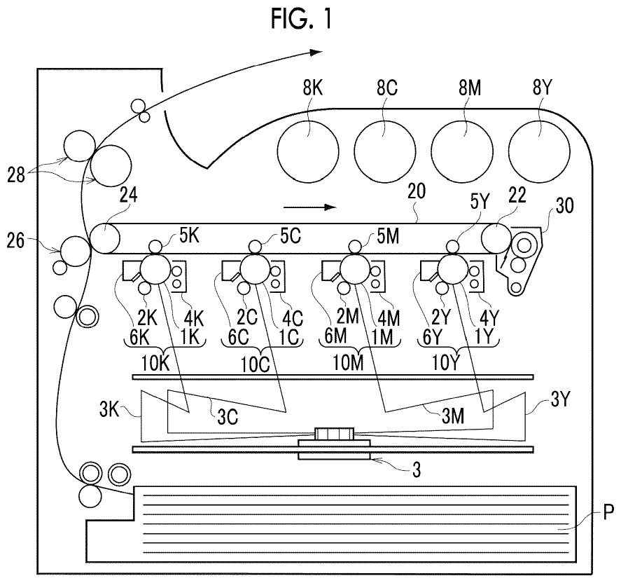

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply referred to as “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of the intermediate transfer member) 20 passing through above the units 10Y, 10M, 10C, and 10K extends under the units. The intermediate transfer belt 20 is looped around a driving roll 22 and a support roll 24, and runs toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

Yellow, magenta, cyan, and black toners contained in containers of toner cartridges 8Y, 8M, 8C, and 8K are supplied to developing devices (an example of the developing device) 4Y, 4M, 4C, and 4K of the units 10Y, 10M, 10C, and 10K, respectively.

The first to fourth units 10Y, 10M, 10C, and 10K have the same configuration and operation. Therefore, in the present specification, as a representative, the first unit 10Y will be described that is placed on the upstream side of the running direction of the intermediate transfer belt and forms a yellow image.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. A bias power supply (not shown in the drawing) for applying a primary transfer bias is connected to primary transfer rolls 5Y, 5M, 5C, and 5K of each unit. Each bias power supply changes the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. From the exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

On the other hand, the residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt 20, and a secondary transfer roll 26 (an example of the secondary transfer device) disposed on the outer peripheral surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawings, main parts will be described, and others will not be described.

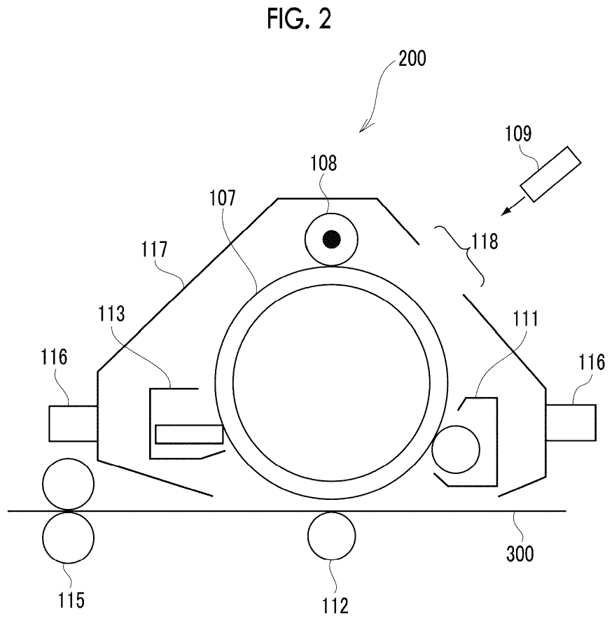

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

### EXAMPLES

Hereinafter, the present exemplary embodiments will be specifically described based on Examples. However, the present exemplary embodiments are not limited to Examples. In the following description, unless otherwise specified, “parts” and “%” are based on mass.

In the following description, the synthesis, the treatment, the production, the test, and the like are carried out at room temperature (25° C.±3° C.) unless otherwise specified.

### Production of Carrier

### Production of Ferrite Particles (1)

| | | |
|---|---|---|
| Fe₂O₃: | 1597 | parts |
| Mn(OH)₂: | 712 | parts |
| Mg(OH)₂: | 116 | parts |
| SrCO₃: | 20 | parts |
| CaCO₃: | 30 | parts |

The above-described materials are mixed with each other, a dispersant, water, and zirconia beads having a diameter of 1 mm are added thereto, and the mixture is crushed and mixed using a sand mill. The zirconia beads are separated by filtration, and the filtrate is dried and then temporarily fired using a rotary kiln under the conditions of rotation speed of 20 rpm/temperature of 970° C./2 hours. A dispersant and water are added to the obtained temporarily baked product, and 8 parts of polyvinyl alcohol is further added thereto, followed by pulverization and mixing for 5 hours using a wet ball mill. A volume-average particle size of the obtained pulverized product is 1.2 μm. Next, the product is made into granules having a particle size of 40 μm using a spray dryer. The obtained granulated product is permanently baked using an electric furnace in an oxygen/nitrogen mixed atmosphere having an oxygen concentration of 1% by volume under conditions of temperature of 1,400° C./4 hours. The obtained baked product is crushed and classified to obtain ferrite particles (1). A volume-average particle size of the ferrite particles (1) is 35 μm.

### Preparation of Coating Agent for First Layer and Coating Agent for Second Layer

In the present example, the value of B−A is controlled by a method of forming the resin coating layer a plurality of times. The present example is an example of a method of controlling the value of B−A, but the method of controlling the value of B−A is not limited thereto.

Each component shown in Tables 1-1 and 1-2 is put into a sand mill together with glass beads (diameter: 1 mm, the same amount as toluene) at a mass ratio shown in Table 1-1, and the mixture is stirred at a rotation speed of 190 rpm for 30 minutes to prepare each of a coating agent for a first layer and a coating agent for a second layer.

Details of the abbreviations of the respective components of the coating agents described in Tables 1-1 and 1-2 are as follows.
Resin (1): cyclohexyl methacrylate/2-(dimethylamino)ethyl methacrylate copolymer (copolymerization ratio: 97 mol:3 mol)
Resin (2): cyclohexyl methacrylate/methyl methacrylate copolymer (copolymerization ratio: 95 mol:5 mol)
Resin (3): methyl methacrylate polymer
Surface-treated silica (S1): silica particles (HM20S, Tokuyama Corporation, average primary particle size: 12 nm, surface treatment agent: hexamethyldisilazane)
Surface-treated silica (S2): silica particles (NX90S, Nippon Aerosil Co., Ltd., average primary particle size: 22 nm, surface treatment agent: hexamethyldisilazane)
Surface-treated silica (S3): silica particles (RY200, Nippon Aerosil Co., Ltd., average primary particle size: 12 nm, surface treatment agent: hexamethyldisilazane)
Surface-treated silica (S4): silica particles (HM30S, Tokuyama Corporation, average primary particle size: 7 nm, surface treatment agent: hexamethyldisilazane)
Surface-treated silica (S5): silica particles (average primary particle size: 30 nm, dried silica, surface treatment agent: hexamethyldisilazane)
Surface-treated silica (S6): silica particles (average primary particle size: 40 nm, dried silica, surface treatment agent: hexamethyldisilazane)
Surface-treated silica (S7): silica particles (RX50, Nippon Aerosil Co., Ltd., average primary particle size: 65 nm, surface treatment agent: hexamethyldisilazane)
Silica without surface treatment (Sn): silica particles (QS-20, Tokuyama Corporation, average primary particle size: 12 nm)
Surface-treated alumina (A): alumina particles (AluC 805, Nippon Aerosil Co., Ltd., average primary particle size: 22 nm, surface treatment agent: octylsilane)
Surface-treated titania (T): titania particles (T805, Nippon Aerosil Co., Ltd., average primary particle size: 20 nm, surface treatment agent: octylsilane)
Resin particles (M1): melamine resin particles (EPOSTAR FS, manufactured by NIPPON SHOKUBAI CO., LTD., average primary particle size: 250 nm)
Resin particles (M2): melamine resin particles (EPOSTAR SS, manufactured by NIPPON SHOKUBAI CO., LTD., average primary particle size: 70 nm)
Resin particles (M3): melamine resin particles (EPOSTAR S, manufactured by NIPPON SHOKUBAI CO., LTD., average primary particle size: 100 nm)
Resin particles (A1): acrylic resin particles (MP-1441, Soken Chemical & Engineering Co., Ltd., average primary particle size: 150 nm)
Resin particles (A2): acrylic resin particles (MP-2200, Soken Chemical & Engineering Co., Ltd., average primary particle size: 350 nm)
Resin particles (M4): melamine resin particles (EPOSTAR S6, manufactured by NIPPON SHOKUBAI CO., LTD., average primary particle size: 400 nm)
Resin particles (M5): melamine resin particles (EPOSTAR 512, manufactured by NIPPON SHOKUBAI CO., LTD., average primary particle size: 900 nm)
CB: carbon black (VXC72, Cabot Corporation)

### Production of Carrier (1)

Using a spin coater (Okada Seiko Co., Ltd.), the surface of 1,000 parts of the ferrite particles (1) is coated with the coating agent for a first layer at a rate of 30 g/min in an atmosphere of 70° C. such that the component of the resin coating layer is 15 parts with respect to the ferrite core material. Next, the coating agent for a second layer is applied thereto at a rate of 30 g/min such that the component of the resin coating layer is 15 parts with respect to the ferrite particles (1), and then dried. The dried powder is taken out from the spin coater and crushed using a sieve having an opening size of 75 μm, thereby obtaining each of carriers (1) to (40) and comparative carriers (C1) and (C2).

In a comparative carrier (C3), using a spin coater (Okada Seiko Co., Ltd.), the surface of 1,000 parts of the ferrite particles (1) is coated with the coating agent for a first layer at a rate of 30 g/min in an atmosphere of 70° C. such that the component of the resin coating layer is 30 parts with respect to the ferrite core material, and then dried. The dried powder is taken out from the spin coater and crushed using a sieve having an opening size of 75 μm, thereby obtaining a comparative carrier (C3).

### Production of Carrier (2)

| Material (1) | | |
|---|---|---|
| Ferrite particles (1): | 1,000 | parts |
| Resin particles of cyclohexyl methacrylate/2- | 4.6 | parts |
| (dimethylamino)ethyl methacrylate copolymer | | |
| (copolymerization ratio: 97 mol:3 mol): | | |
| Surface-treated silica (S1): | 4.0 | parts |
| CB: | 0.4 | parts |
| Resin particles (M1): | 1.0 | part |
| Material (2) | | |
| Resin particles of cyclohexyl methacrylate/2- | 14.7 | parts |
| (dimethylamino)ethyl methacrylate copolymer | | |
| (copolymerization ratio: 97 mol:3 mol): | | |
| Surface-treated silica (S1): | 2.0 | parts |
| CB: | 1.3 | parts |
| Resin particles (M1): | 2.0 | parts |

The above-described material (1) is put in a high-speed mixer with a stirring blade, and stirred at a temperature of 125° C. and a wind speed of 10 m/s for 45 minutes. Next, the above-described material (2) is additionally added thereto, and the mixture is stirred at a temperature of 125° C. and a wind speed of 10 m/s for 45 minutes. A resin coating layer is formed on the surface of the ferrite particles under the action of a mechanical impact force. Next, the wind speed is lowered to 2 m/s, and the temperature is lowered to room temperature to obtain a comparative carrier (C4).

### Production of Carrier (3)

| | | |
|---|---|---|
| Resin particles of cyclohexyl methacrylate/2- | 19.3 | parts |
| (dimethylamino)ethyl methacrylate copolymer | | |
| (copolymerization ratio: 97 mol:3 mol): | | |
| Surface-treated silica (S7): | 6.0 | parts |
| CB: | 1.7 | parts |
| Resin particles (M1): | 3.0 | parts |
| Toluene: | 386.7 | parts |

The above-described material is applied to 1,000 parts of the ferrite particles (1) and dried to obtain a comparative carrier (C5). The coating and drying are performed using a fluidized bed type coating device in which the temperature in the fluidized bed is controlled to 70° C.

### Measurement of Volume-Average Particle Size of Carrier

Using the carrier as a sample, a particle size of the carrier is measured with a laser diffraction/scattering type particle size distribution analyzer (LS Particle Size Analyzer: LS13 320, Beckman Coulter Inc.). A particle diameter (m) at which a cumulative percentage from the small diameter side in the volume-based particle size distribution is 50% is determined.

Volume-average particle sizes of the carriers (1) to (40) and the comparative carriers (C1) to (C5) are 36 μm, respectively.

### Elemental Analysis by XPS

Using the carrier as a sample, carbon, nitrogen, oxygen, iron, manganese, and metals and metalloids constituting the inorganic particles are analyzed by XPS using an etching method.

In a case where the inorganic particles are silica particles, carbon, nitrogen, oxygen, iron, manganese, and silicon are analyzed.

In a case where the inorganic particles are alumina particles, carbon, nitrogen, oxygen, iron, manganese, and aluminum are analyzed.

In a case where the inorganic particles are titania particles, carbon, nitrogen, oxygen, iron, manganese, and titanium are analyzed.

An element ratio (atm %) of the metals and the metalloids constituting the inorganic particles to the total element amount of all elements to be analyzed are determined. The element ratio at 0 seconds of etching is defined as A (atm %) and the element ratio at 300 seconds of etching is defined as B (atm %).

The XPS is performed with the following device and conditions. The analysis is performed after baseline correction.
XPS device: PHI5000 Versa Probe II (ULVAC-PHI, Inc.)
X-ray source: monochromatic Al-Kα ray
Beam voltage: 15 kV
Emission current: 3 mA
Etching gun: argon gas cluster ion gun
Degree of vacuum: 1×10⁻⁵ Pa to 1×10⁻⁶ Pa
Pass Energy: 23.5 eV
Sweep region: 300 μm×300 μm
Time Per Step: 50 seconds
Cycle: 5 times
Sweep: 10 times

### Production of Toner

### Preparation of Emulsion (1-1)

| | | |
|---|---|---|
| Styrene: | 80 | parts |
| n-Butyl acrylate: | 120 | parts |
| 1,10-Decanediol diacrylate (crosslinking agent): | 4 | parts |
| Anionic surfactant (Newcol 271A, Nippon Nyukazai | 2.2 | parts |
| Co., Ltd.): | | |
| Deionized water: | 197.8 | parts |

The above-described materials are charged into a mixing vessel equipped with a stirrer, and stirred to prepare an emulsion (1-1).

### Preparation of Emulsion (1-2)

| | | |
|---|---|---|
| Styrene: | 75 | parts |
| n-Butyl acrylate: | 25 | parts |
| 1,10-Decanediol diacrylate (crosslinking agent): | 1.0 | part |
| Anionic surfactant (Newcol 271A, Nippon Nyukazai | 1.1 | parts |
| Co., Ltd.): | | |
| Deionized water: | 97.7 | parts |

The above-described materials are charged into a mixing vessel equipped with a stirrer, and stirred to prepare an emulsion (1-2).

### Preparation of Internally-added Crosslinked Resin Particle Dispersion (1)

0.5 parts of an anionic surfactant (Newcol 271A, Nippon Nyukazai Co., Ltd.) and 200 parts of deionized water are charged into a reaction vessel equipped with a stirrer and a nitrogen introduction tube, after replacing the inside of the reaction vessel with nitrogen. The reaction solution is heated in an oil bath while being stirred so that a temperature of the reaction solution is raised to 65° C. 10 parts of the emulsion (1-1) is added thereto, 10 parts of an ammonium persulfate aqueous solution having a concentration of 10% by mass is added thereto, and the mixture is allowed to stand for 30 minutes. In a state in which the temperature of the reaction solution is maintained at 65° C., 390 parts of the emulsion (1-1) is added dropwise to the reaction vessel over 60 minutes. Next, 200 parts of the emulsion (1-2) is added dropwise thereto over 30 minutes. After the dropwise addition is completed, the solution is kept at a temperature of 65° C. for 60 minutes. Next, 2 parts of ammonium persulfate having a concentration of 10% by mass is added thereto, and the mixture is kept at a temperature of 65° C. for 3 hours. Next, the mixture is cooled to room temperature, and deionized water is added thereto such that a concentration of solid contents is 20% by mass, thereby obtaining an internally-added crosslinked resin particle dispersion (1). The resin particles have a volume-average particle size of 165 nm and a glass transition temperature of 17° C.

### Preparation of Internally-Added Crosslinked Resin Particle Dispersions (2) to (7)

Internally-added crosslinked resin particle dispersions (2) to (7) are prepared in the same manner as in the internally-added crosslinked resin particle dispersion (1), except that the amount of the materials used is changed as shown in Table 2.

### Preparation of Amorphous Polyester Resin Particle Dispersion (1)

| | | |
|---|---|---|
| Terephthalic acid: | 25 | parts by mole |
| Isophthalic acid: | 19 | parts by mole |
| Adipic acid: | 3 | parts by mole |
| Trimellitic anhydride: | 2 | parts by mole |
| Propylene oxide (2 mol) adduct of bisphenol A: | 31 | parts by mole |
| Propylene oxide (3 mol) adduct of bisphenol A: | 20 | parts by mole |

The above-described materials are charged into a reaction vessel equipped with a stirrer, a nitrogen introduction tube, a temperature sensor, and a rectifying column, the temperature is raised to 190° C. over 1 hour, and dibutyltin oxide is added thereto in an amount of 1.2 parts with respect to 100 parts of the materials. While the generated water is distilled off, the temperature is raised to 240° C. over 6 hours, and a dehydration condensation reaction is continued for 3 hours in the reaction solution kept at 240° C. Next, the reaction solution is cooled to room temperature, thereby obtaining an amorphous polyester resin (1). The amorphous polyester resin (1) has an acid value of 10 mgKOH/g, a glass transition temperature of 61° C., and a weight-average molecular weight of 25,000.

| | | |
|---|---|---|
| Amorphous polyester resin (1): | 100 | parts |
| Methyl ethyl ketone: | 60 | parts |
| Isopropanol: | 10 | parts |
| 10% ammonia aqueous solution: | 3.5 | parts |

The above-described materials are put in a jacketed reaction tank equipped with a condenser, a thermometer, a water dripping device, and an anchor blade, and in a state in which the reaction tank is retained at a liquid temperature of 50° C. in a water-circulation type thermostatic bath, the amorphous polyester resin (1) is dissolved while stirring and mixing the mixture at 100 rpm. Next, the water-circulation type thermostatic bath is set to 40° C., and a total of 300 parts of deionized water retained at 40° C. is added dropwise to the reaction tank at a rate of 3 parts/min to cause phase inversion, thereby obtaining an emulsion. The emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the dispersion, thereby obtaining an amorphous polyester resin particle dispersion (1) having a solid content of 20% by mass. A volume-average particle size of the amorphous polyester resin particles is 180 nm.

### Preparation of Amorphous Polyester Resin Particle Dispersions (2) to (19)

Amorphous polyester resin particle dispersions (2) to (19) are prepared in the same manner as in the amorphous polyester resin particle dispersion (1), except that the amounts of the materials used are changed as shown in Table 3-1.

Details of abbreviations of the respective components described in Table 3-1 are as follows.
Monomer (A): aliphatic dicarboxylic acid for forming the constitutional unit represented by Formula (A)
Monomer (B): aliphatic diol for forming the constitutional unit represented by Formula (B)
TPA: terephthalic acid
IPA: isophthalic acid
TMA: trimellitic anhydride
BPA-2PO: propylene oxide (2 mol) adduct of bisphenol A
BPA-3PO: propylene oxide (3 mol) adduct of bisphenol A
BPA-2EO: ethylene oxide (2 mol) adduct of bisphenol A

### Preparation of Crystalline Polyester Resin Particle Dispersion (1)

| | |
|---|---|
| Dodecanedioic acid: | 50 parts by mole |
| 1,6-Hexanediol: | 50 parts by mole |

The above-described materials are charged into a reaction vessel equipped with a stirrer, a nitrogen introduction tube, a temperature sensor, and a rectifying column, the temperature is raised to 160° C. over 1 hour, and dibutyltin oxide is added thereto in an amount of 0.8 parts with respect to 100 parts of the materials. While the generated water is distilled off, the temperature is raised to 180° C. for 6 hours, and while maintaining the temperature at 180° C. and stirring for 5 hours, the reaction is allowed to progress by refluxing in the container. Next, the temperature is slowly raised to 230° C. under reduced pressure (3 kPa), and the reaction solution is stirred for 2 hours in a state of being retained at 230° C. Next, the reaction product is cooled, solid-liquid separation is performed, and the solids are dried to obtain a crystalline polyester resin (1). The crystalline polyester resin (1) has an acid value of 8.8 mgKOH/g and a weight-average molecular weight of 29,000.

| | | |
|---|---|---|
| Crystalline polyester resin (1): | 100 | parts |
| Methyl ethyl ketone: | 70 | parts |
| Isopropanol: | 12 | parts |
| 10% ammonia aqueous solution: | 3 | parts |

The above-described materials are put in a jacketed reaction tank equipped with a condenser, a thermometer, a water dripping device, and an anchor blade, and in a state in which the reaction tank is retained at a liquid temperature of 80° C. in a water-circulation type thermostatic bath, the crystalline polyester resin (1) is dissolved while stirring and mixing the mixture at 100 rpm. Next, the water-circulation type thermostatic bath is set to 60° C., and a total of 300 parts of deionized water retained at 60° C. is added dropwise to the reaction tank at a rate of 3 parts/min to cause phase inversion, thereby obtaining an emulsion. The emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the dispersion, thereby obtaining a crystalline polyester resin particle dispersion (1) having a solid content of 20% by mass. A volume-average particle size of the crystalline polyester resin particles is 160 nm.

### Preparation of Release Agent Particle Dispersion

| | | |
|---|---|---|
| Fischer-Tropsch wax (Sasol wax H1, SASOL): | 100 | parts |
| Anionic surfactant (NEOPELEX G-65, Kao Corporation): | 6 | parts |
| Deionized water: | 300 | parts |

The above-described materials are mixed together, heated to 100° C., and dispersed using a homogenizer (ULTRA-TURRAX T50). Furthermore, a dispersion treatment is performed using a Manton-Gaulin high-pressure homogenizer, and deionized water is added to the dispersion, thereby obtaining a release agent particle dispersion having a solid content of 20% by mass. A volume-average particle size of the release agent particles is 230 nm.

### Preparation of Colorant Dispersion

| | | |
|---|---|---|
| Carbon black (Regel 330, Cabot Corporation.): | 110 | parts |
| Anionic surfactant (NEOPELEX G-65, Kao Corporation): | 6 | parts |
| Deionized water: | 300 | parts |

The above-described materials are mixed together and dispersed for 10 minutes using a homogenizer (ULTRA-TURRAX T50). Deionized water is added to the dispersion, thereby obtaining a colorant dispersion having a solid content of 20% by mass. A volume-average particle size of the colorant particles is 220 nm.

### Production of Toner (1)

| | | |
|---|---|---|
| Amorphous polyester resin particle dispersion (1): | 61.7 | parts |
| Crystalline polyester resin particle dispersion (1): | 15.4 | parts |
| Internally-added crosslinked resin particle dispersion (1): | 10 | parts |
| Colorant dispersion: | 6.9 | parts |
| Release agent particle dispersion: | 6.0 | parts |
| Anionic surfactant (ELEMINOL MON-2, Sanyo Chemical | 1.6 | parts |
| Industries, Ltd.): | | |
| Deionized water: | 80 | parts |

The above-described materials are put in a reaction vessel equipped with a thermometer, a pH meter, and a stirrer, and the temperature of the reaction vessel is kept at 20° C. and retained for 30 minutes while stirring at a rotation speed of 150 rpm. Next, a 0.3N nitric acid aqueous solution is added thereto such that the pH is adjusted to 5.0, and then 12 parts of 1% aluminum sulfate aqueous solution is added thereto in a state in which the reaction solution is dispersed with a homogenizer (ULTRA-TURRAX T50). Next, in a state in which the reaction solution is stirred, the temperature thereof is raised to 45° C. at a rate of 0.4° C./min and retained for 30 minutes.

Next, 29 parts of the amorphous polyester resin particle dispersion (1) is added thereto, and the mixture is retained for 30 minutes.

Next, 0.62 parts of CHELEST 40 (Chelest Corporation, content: 40%) is added thereto. Next, a 0.1 N sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours. Next, after cooling, solid-liquid separation, and washing of solid matter with deionized water, the solid matter is dried for 24 hours in a freeze vacuum dryer to obtain toner particles (1) having a volume-average particle size of 5.5 μm.

100 parts of the toner particles (1) and 2.0 parts of hydrophobic silica (RY200, Nippon Aerosil Co., Ltd.) are mixed with a Henshell mixer to obtain a toner (1).

### Preparation of Toner (2) to (41) and Comparative Toners (C1) and (C2)

Toners (2) to (41) and comparative toners (C1) and (C2) are obtained in the same manner as in the toner (1), except that the type and the amount of each resin particle dispersion used are changed as shown in Table 4-1. A solid content of each resin particle dispersion is set to 20% by mass.

Various characteristics of the toner particles measured by the above-described measurement methods are shown in Tables 4-2 and 4-3.

### Production of Developer

### Examples 1-1 to 1-40 and Comparative Examples 1-1 to 1-5

The type of toner is fixed and the type of carrier is changed as shown in Table 1-1, thereby preparing developers of Examples 1-1 to 1-40 and Comparative Examples 1-1 to 1-5.

100 parts of the carrier and 6 parts of the toner are charged into a V-blender, and stirred for 20 minutes. Thereafter, the mixture is sieved using a sieve having an opening size of 212 μm, thereby obtaining a developer.

### Examples 2-1 to 2-41 and Comparative Examples 2-1 and 2-2

The type of carrier is fixed and the type of toner is changed as shown in Table 4-3, thereby preparing developers of Examples 2-1 to 2-41 and Comparative Examples 2-1 and 2-2.

100 parts of the carrier and 6 parts of the toner are charged into a V-blender, and stirred for 20 minutes. Thereafter, the mixture is sieved using a sieve having an opening size of 212 m, thereby obtaining a developer.

### Performance Evaluation

### Stability of Image Density

The developer is filled in a developing device of a modified machine of an image forming apparatus Apeos C4030 (FUJIFILM Business Innovation Corp.). Image formation is performed on A4 size plain paper in the following order of (1) to (3).

(1) an image having an image density of 100% is output on 1 sheet in an environment at a temperature of 25° C. and a relative humidity of 90%.

(2) an image having an image density of 0.5% is output on 10,000 sheets in an environment at a temperature of 25° C. and a relative humidity of 90%.

(3) an image having an image density of 100% is output on 10,000 sheets in an environment of a temperature of 10° C. and a relative humidity of 15%.

The image density of the one sheet in (1) and the image density of the last one sheet in (3) are measured with an image densitometer (X-Rite 938, X-Rite Inc.), an image density difference Δ is calculated, and the value of the image density difference Δ is classified as follows. For example, it is desirable that the image density difference Δ is smaller. The evaluation results are shown in Tables 1-2 and 4-3.
A: 0.00 or more and less than 0.05
B++: 0.05 or more and less than 0.07
B+: 0.07 or more and less than 0.09
B: 0.09 or more and less than 0.12
C++: 0.12 or more and less than 0.14
C+: 0.14 or more and less than 0.16
C: 0.16 or more and less than 0.20
D: 0.20 or more and less than 0.25
E: 0.25 or more

TABLE 1-1

| | | | | Formulation of coating agent | | | | | | | Formulation of coating agent | | | | | | |
|---|---|---|---|---|---|---|---|---|---|---|---|---|---|---|---|---|---|
| | | | | for first layer (inner side) | | | | | | | for second layer (outside) | | | | | | |
| | | | Coating | | | | | | Resin | | | | | | | Resin | |
| | Toner | Carrier | resin | | | Alu- | Tita- | | par- | | | | Alu- | Tita- | | par- | |
| | Type | Type | Type | Resin | Silica | mina | nia | CB | ticles | Toluene | Resin | Silica | mina | nia | CB | ticles | Toluene |
| Developer | — | − | − | Part by mass | | | | | | | Part by mass | | | | | | |
| Example 1-1 | (33) | (1) | (1) | 4.6 | 4.0 | — | — | 0.4 | 1.0 | 92.1 | 14.7 | 2.0 | — | — | 1.3 | 2.0 | 294.6 |
| Example 1-2 | (33) | (2) | (1) | 5.1 | 4.1 | — | — | 0.4 | 1.1 | 102.6 | 14.2 | 1.9 | — | — | 1.2 | 1.9 | 284.1 |
| Example 1-3 | (33) | (3) | (1) | 5.7 | 4.2 | — | — | 0.5 | 1.2 | 114.7 | 13.6 | 1.8 | — | — | 1.2 | 1.8 | 272.0 |
| Example 1-4 | (33) | (4) | (1) | 6.4 | 4.3 | — | — | 0.6 | 1.3 | 128.9 | 12.9 | 1.8 | — | — | 1.1 | 1.8 | 257.8 |
| Example 1-5 | (33) | (5) | (1) | 7.3 | 4.4 | — | — | 0.6 | 1.4 | 145.6 | 12.1 | 1.6 | — | — | 1.0 | 1.6 | 241.1 |
| Example 1-6 | (33) | (6) | (1) | 4.1 | 3.9 | — | — | 0.4 | 0.9 | 82.9 | 15.2 | 2.1 | — | — | 1.3 | 2.1 | 303.8 |
| Example 1-7 | (33) | (7) | (1) | 3.7 | 3.9 | — | — | 0.3 | 0.9 | 74.7 | 15.6 | 2.1 | — | — | 1.3 | 2.1 | 312.0 |
| Example 1-8 | (33) | (8) | (1) | 3.4 | 3.8 | — | — | 0.3 | 0.8 | 67.5 | 16.0 | 2.2 | — | — | 1.4 | 2.2 | 319.2 |
| Example 1-9 | (33) | (9) | (1) | 3.1 | 3.8 | — | — | 0.3 | 0.8 | 61.1 | 16.3 | 2.2 | — | — | 1.4 | 2.2 | 325.6 |
| Comparative | (33) | (C1) | (1) | 8.3 | 4.5 | | | 0.7 | 1.5 | 165.7 | 11.0 | 1.5 | — | — | 1.0 | 1.5 | 221.0 |
| Example 1-1 | | | | | | | | | | | | | | | | | |
| Comparative | (33) | (C2) | (1) | 2.8 | 3.8 | — | — | 0.2 | 0.8 | 55.2 | 16.6 | 2.3 | — | — | 1.4 | 2.3 | 331.5 |
| Example 1-2 | | | | | | | | | | | | | | | | | |
| Example 1-10 | (33) | (10) | (1) | 8.9 | 5.6 | — | — | 0.8 | 1.7 | 178.4 | 10.4 | 0.4 | — | — | 0.9 | 1.3 | 208.3 |
| Example 1-11 | (33) | (11) | (1) | 7.6 | 5.3 | — | — | 0.7 | 1.5 | 151.9 | 11.7 | 0.8 | — | — | 1.0 | 1.5 | 234.8 |
| Example 1-12 | (33) | (12) | (1) | 6.3 | 4.8 | — | — | 0.5 | 1.3 | 126.9 | 13.0 | 1.2 | — | — | 1.1 | 1.7 | 259.8 |
| Example 1-13 | (33) | (13) | (1) | 5.2 | 4.3 | — | — | 0.4 | 1.1 | 103.3 | 14.2 | 1.7 | — | — | 1.2 | 1.9 | 283.4 |
| Example 1-14 | (33) | (14) | (1) | 3.5 | 3.4 | — | — | 0.3 | 0.8 | 70.7 | 15.8 | 2.6 | — | — | 1.4 | 2.2 | 316.0 |
| Example 1-15 | (33) | (15) | (1) | 2.5 | 2.6 | — | — | 0.2 | 0.6 | 50.8 | 16.8 | 3.4 | — | — | 1.4 | 2.4 | 335.9 |
| Example 1-16 | (33) | (16) | (1) | 1.6 | 1.8 | — | — | 0.1 | 0.4 | 32.4 | 17.7 | 4.2 | — | — | 1.5 | 2.6 | 354.3 |
| Example 1-17 | (33) | (17) | (1) | 0.8 | 1.0 | — | — | 0.1 | 0.2 | 15.5 | 18.6 | 5.0 | — | — | 1.6 | 2.8 | 371.2 |
| Example 1-18 | (33) | (18) | (1) | 4.6 | 4.0 | — | — | 0.4 | 1.0 | 92.1 | 14.7 | 2.0 | — | — | 1.3 | 2.0 | 294.6 |
| Example 1-19 | (33) | (19) | (1) | 5.2 | — | 4.5 | — | 0.4 | 1.1 | 103.7 | 15.1 | — | 2.0 | — | 1.3 | 2.0 | 301.5 |
| Example 1-20 | (33) | (20) | (1) | 5.3 | — | — | 4.6 | 0.5 | 1.1 | 105.3 | 15.2 | — | — | 2.1 | 1.3 | 2.1 | 304.4 |
| Example 1-21 | (33) | (21) | (1) | 4.6 | 4.0 | — | — | 0.4 | 1.0 | 92.1 | 14.7 | 2.0 | — | — | 1.3 | 2.0 | 294.6 |
| Example 1-22 | (33) | (22) | (1) | 4.6 | 4.0 | — | — | 0.4 | 1.0 | 92.1 | 14.7 | 2.0 | — | — | 1.3 | 2.0 | 294.6 |
| Example 1-23 | (33) | (23) | (1) | 1.8 | 1.6 | — | — | 0.2 | 0.4 | 36.8 | 19.2 | 2.6 | — | — | 1.6 | 2.6 | 383.0 |
| Example 1-24 | (33) | (24) | (1) | 2.8 | 2.4 | — | — | 0.2 | 0.6 | 55.2 | 17.7 | 2.4 | — | — | 1.5 | 2.4 | 353.6 |
| Example 1-25 | (33) | (25) | (1) | 10.6 | 9.2 | — | — | 0.9 | 2.3 | 211.8 | 5.2 | 0.7 | — | — | 0.4 | 0.7 | 103.1 |
| Example 1-26 | (33) | (26) | (1) | 12.4 | 10.8 | — | — | 1.1 | 2.7 | 248.6 | 2.2 | 0.3 | — | — | 0.2 | 0.3 | 44.2 |
| Example 1-27 | (33) | (27) | (1) | 6.0 | 4.0 | — | — | 1 | 1 | 120.0 | 18.0 | 2.0 | — | — | — | — | 360.0 |
| Comparative | (33) | (C3) | (1) | 19.3 | 6.0 | — | — | 1.7 | 3.0 | 386.7 | — | | | | | | |
| Example 1-3 | | | | | | | | | | | | | | | | | |
| Example 1-28 | (33) | (28) | (2) | 4.6 | 4.0 | — | — | 0.4 | 1.0 | 92.1 | 14.7 | 2.0 | — | — | 1.3 | 2.0 | 294.6 |
| Example 1-29 | (33) | (29) | (1) | 4.6 | 4.0 | — | — | 0.4 | 1.0 | 92.1 | 14.7 | 2.0 | — | — | 1.3 | 2.0 | 294.6 |
| Example 1-30 | (33) | (30) | (1) | 4.6 | 4.0 | — | — | 0.4 | 1.0 | 92.1 | 14.7 | 2.0 | — | — | 1.3 | 2.0 | 294.6 |
| Example 1-31 | (33) | (31) | (1) | 4.6 | 4.0 | — | — | 0.4 | 1.0 | 92.1 | 14.7 | 2.0 | — | — | 1.3 | 2.0 | 294.6 |
| Example 1-32 | (33) | (32) | (1) | 4.6 | 4.0 | — | — | 0.4 | 1.0 | 92.1 | 14.7 | 2.0 | — | — | 1.3 | 2.0 | 294.6 |
| Example 1-33 | (33) | (33) | (1) | 4.6 | 4.0 | — | — | 0.4 | 1.0 | 92.1 | 14.7 | 2.0 | — | — | 1.3 | 2.0 | 294.6 |
| Example 1-34 | (33) | (34) | (1) | 4.6 | 4.0 | — | — | 0.4 | 1.0 | 92.1 | 14.7 | 2.0 | — | — | 1.3 | 2.0 | 294.6 |
| Example 1-35 | (33) | (35) | (1) | 4.6 | 4.0 | — | — | 0.4 | 1.0 | 92.1 | 14.7 | 2.0 | — | — | 1.3 | 2.0 | 294.6 |
| Example 1-36 | (33) | (36) | (1) | 4.6 | 4.0 | — | — | 0.4 | 1.0 | 92.1 | 14.7 | 2.0 | — | — | 1.3 | 2.0 | 294.6 |
| Example 1-37 | (33) | (37) | (1) | 4.6 | 4.0 | — | — | 0.4 | 1.0 | 92.1 | 14.7 | 2.0 | — | — | 1.3 | 2.0 | 294.6 |
| Example 1-38 | (33) | (38) | (1) | 4.6 | 4.0 | — | — | 0.4 | 1.0 | 92.1 | 14.7 | 2.0 | — | — | 1.3 | 2.0 | 294.6 |
| Example 1-39 | (33) | (39) | (1) | 4.6 | 4.0 | — | — | 0.4 | 1.0 | 92.1 | 14.7 | 2.0 | — | — | 1.3 | 2.0 | 294.6 |
| Example 1-40 | (33) | (40) | (3) | 4.6 | 4.0 | — | — | 0.4 | 1.0 | 92.1 | 14.7 | 2.0 | — | — | 1.3 | 2.0 | 294.6 |
| Comparative | (33) | (C4) | (1) | 4.6 | 4.0 | — | — | 0.4 | 1.0 | — | 14.7 | 2.0 | — | — | 1.3 | 2.0 | — |
| Example 1-4 | | | | | | | | | | | | | | | | | |
| Comparative | (33) | (C5) | (1) | 19.3 | 6.0 | — | — | 1.7 | 3.0 | 386.7 | — | | | | | | |
| Example 1-5 | | | | | | | | | | | | | | | | | |

TABLE 1-2

| | Content of inorganic particles | | Inorganic particles | | | Resin particles | | | | | | Image |
|---|---|---|---|---|---|---|---|---|---|---|---|---|
| | First layer | Second layer | | Particle | | | Particle | Element ratio | | | Particle | density |
| | (inner side) | (outside) | Type | size D1 | Content | Type | size D2 | A | B | B − A | size ratio | stability |
| Developer | % by mass | % by mass | — | nm | % by mass | — | nm | atm % | | | D1/D2 | — |
| Example 1-1 | 40 | 10 | (S1) | 12 | 20 | (M1) | 250 | 3.5 | 5.3 | 1.8 | 0.048 | A |
| Example 1-2 | 38 | 10 | (S1) | 12 | 20 | (M1) | 250 | 3.5 | 4.7 | 1.2 | 0.048 | A |
| Example 1-3 | 36 | 10 | (S1) | 12 | 20 | (M1) | 250 | 3.5 | 4.5 | 1.0 | 0.048 | B |
| Example 1-4 | 34 | 10 | (S1) | 12 | 20 | (M1) | 250 | 3.5 | 4.3 | 0.8 | 0.048 | C |
| Example 1-5 | 32 | 10 | (S1) | 12 | 20 | (M1) | 250 | 3.5 | 4.0 | 0.5 | 0.048 | D |
| Example 1-6 | 42 | 10 | (S1) | 12 | 20 | (M1) | 250 | 3.5 | 5.8 | 2.3 | 0.048 | A |
| Example 1-7 | 44 | 10 | (S1) | 12 | 20 | (M1) | 250 | 3.5 | 6.0 | 2.5 | 0.048 | B |
| Example 1-8 | 46 | 10 | (S1) | 12 | 20 | (M1) | 250 | 3.5 | 6.2 | 2.7 | 0.048 | C |
| Example 1-9 | 48 | 10 | (S1) | 12 | 20 | (M1) | 250 | 3.5 | 6.5 | 3.0 | 0.048 | D |
| Comparative | 30 | 10 | (S1) | 12 | 20 | (M1) | 250 | 3.5 | 3.9 | 0.4 | 0.048 | E |
| Example 1-1 | | | | | | | | | | | | |
| Comparative | 50 | 10 | (S1) | 12 | 20 | (M1) | 250 | 3.5 | 6.6 | 3.1 | 0.048 | E |
| Example 1-2 | | | | | | | | | | | | |
| Example 1-10 | 33 | 3 | (S1) | 12 | 20 | (M1) | 250 | 1.6 | 3.4 | 1.8 | 0.048 | C |
| Example 1-11 | 35 | 5 | (S1) | 12 | 20 | (M1) | 250 | 1.7 | 3.5 | 1.8 | 0.048 | B |
| Example 1-12 | 37 | 7 | (S1) | 12 | 20 | (M1) | 250 | 2.5 | 4.3 | 1.8 | 0.048 | B+ |
| Example 1-13 | 39 | 9 | (S1) | 12 | 20 | (M1) | 250 | 3.0 | 4.8 | 1.8 | 0.048 | A |
| Example 1-14 | 42 | 12 | (S1) | 12 | 20 | (M1) | 250 | 6.0 | 7.8 | 1.8 | 0.048 | A |
| Example 1-15 | 44 | 14 | (S1) | 12 | 20 | (M1) | 250 | 8.0 | 9.8 | 1.8 | 0.048 | B+ |
| Example 1-16 | 46 | 16 | (S1) | 12 | 20 | (M1) | 250 | 10.2 | 12.0 | 1.8 | 0.048 | B |
| Example 1-17 | 48 | 18 | (S1) | 12 | 20 | (M1) | 250 | 11.0 | 12.8 | 1.8 | 0.048 | C |
| Example 1-18 | 40 | 10 | (Sn) | 12 | 20 | (M1) | 250 | 3.5 | 5.3 | 1.8 | 0.048 | B |
| Example 1-19 | 40 | 10 | (A) | 22 | 20 | (M1) | 250 | 3.5 | 5.3 | 1.8 | 0.088 | B |
| Example 1-20 | 40 | 10 | (T) | 20 | 20 | (M1) | 250 | 3.5 | 5.3 | 1.8 | 0.080 | B |
| Example 1-21 | 40 | 10 | (S2) | 22 | 20 | (M1) | 250 | 3.2 | 5.0 | 1.8 | 0.088 | B+ |
| Example 1-22 | 40 | 10 | (S3) | 12 | 20 | (M1) | 250 | 2.5 | 4.3 | 1.8 | 0.048 | B |
| Example 1-23 | 40 | 10 | (S1) | 12 | 14 | (M1) | 250 | 3.5 | 5.3 | 1.8 | 0.048 | C |
| Example 1-24 | 40 | 10 | (S1) | 12 | 15 | (M1) | 250 | 3.5 | 5.3 | 1.8 | 0.048 | B |
| Example 1-25 | 40 | 10 | (S1) | 12 | 35 | (M1) | 250 | 3.5 | 5.3 | 1.8 | 0.048 | B |
| Example 1-26 | 40 | 10 | (S1) | 12 | 37 | (M1) | 250 | 3.5 | 5.3 | 1.8 | 0.048 | C |
| Example 1-27 | 40 | 10 | (S1) | 12 | 20 | — | — | 4.8 | 5.3 | 0.5 | | D |
| Comparative | 20 | 0 | (S1) | 12 | 20 | (M1) | 250 | 8.0 | 8.0 | 0.0 | 0.048 | E |
| Example 1-3 | | | | | | | | | | | | |
| Example 1-28 | 40 | 10 | (S1) | 12 | 20 | (M1) | 250 | 3.2 | 4.8 | 1.6 | 0.048 | B+ |
| Example 1-29 | 40 | 10 | (S1) | 12 | 20 | (M2) | 70 | 3.5 | 4.4 | 0.9 | 0.171 | C |
| Example 1-30 | 40 | 10 | (S1) | 12 | 20 | (M3) | 100 | 3.5 | 4.6 | 1.1 | 0.120 | B |
| Example 1-31 | 40 | 10 | (S1) | 12 | 20 | (A1) | 150 | 3.5 | 5.1 | 1.6 | 0.080 | A |
| Example 1-32 | 40 | 10 | (S1) | 12 | 20 | (A2) | 350 | 3.5 | 5.4 | 1.9 | 0.034 | A |
| Example 1-33 | 40 | 10 | (S1) | 12 | 20 | (M4) | 400 | 3.5 | 5.5 | 2.0 | 0.030 | A |
| Example 1-34 | 40 | 10 | (S1) | 12 | 20 | (M5) | 900 | 3.3 | 5.7 | 2.4 | 0.013 | B |
| Example 1-35 | 40 | 10 | (S4) | 7 | 20 | (M5) | 900 | 3.3 | 5.9 | 2.6 | 0.008 | C |
| Example 1-36 | 40 | 10 | (S7) | 55 | 20 | (M4) | 400 | 3.7 | 4.4 | 0.7 | 0.163 | D |
| Example 1-37 | 40 | 10 | (S4) | 7 | 20 | (A1) | 150 | 3.3 | 5.3 | 2.0 | 0.047 | A |
| Example 1-38 | 40 | 10 | (S5) | 30 | 20 | (A2) | 350 | 3.5 | 5.9 | 2.4 | 0.086 | B+ |
| Example 1-39 | 40 | 10 | (S6) | 40 | 20 | (M4) | 400 | 3.6 | 6.2 | 2.6 | 0.100 | B |
| Example 1-40 | 40 | 10 | (S1) | 12 | 20 | (M1) | 250 | 3.2 | 4.7 | 1.5 | 0.048 | B |
| Comparative | 40 | 10 | (S1) | 12 | 20 | (M1) | 250 | 3.5 | 3.5 | 0.0 | 0.048 | E |
| Example 1-4 | | | | | | | | | | | | |
| Comparative | 20 | 0 | (S7) | 65 | 20 | (M1) | 250 | 8.2 | 8.2 | 0.0 | 0.260 | E |
| Example 1-5 | | | | | | | | | | | | |

TABLE 2

| | Emulsion 1-1 | | | | | Emulsion 1-2 | | | | | Crosslinked | |
|---|---|---|---|---|---|---|---|---|---|---|---|---|
| Internally- | Monomer | | Crosslinking agent | | Anionic | Monomer | | Crosslinking agent | | Anionic | resin | |
| added | | n-Butyl | | Addition | surfac- | | n-Butyl | | Addition | surfac- | | Par- |
| crosslinked | Styrene | acrylate | | amount | tant | Styrene | acrylate | | amount | tant | | ticle |
| resin particle | Part by | Part by | Type | Part by | Part by | Part by | Part by | Type | Part by | Part by | Tg | size |
| dispersion | mass | mass | — | mass | mass | mass | mass | — | mass | mass | ° C. | nm |
| (1) | 80 | 120 | 1,10-Decanediol | 4 | 2.2 | 75 | 25 | 1,10-Decanediol | 1 | 1.1 | 17 | 165 |
| | | | diacrylate | | | | | diacrylate | | | | |
| (2) | 50 | 150 | 1,10-Decanediol | 4 | 2.2 | 60 | 40 | 1,10-Decanediol | 1 | 1.1 | −3 | 166 |
| | | | diacrylate | | | | | diacrylate | | | | |
| (3) | 70 | 130 | 1,10-Decanediol | 4 | 2.2 | 55 | 50 | 1,10-Decanediol | 1 | 1.1 | 3 | 170 |
| | | | diacrylate | | | | | diacrylate | | | | |
| (4) | 110 | 90 | 1,10-Decanediol | 4 | 2.2 | 80 | 20 | 1,10-Decanediol | 1 | 1.1 | 37 | 162 |
| | | | diacrylate | | | | | diacrylate | | | | |
| (5) | 130 | 70 | 1,10-Decanediol | 4 | 2.2 | 75 | 35 | 1,10-Decanediol | 1 | 1.1 | 42 | 165 |
| | | | diacrylate | | | | | diacrylate | | | | |
| (6) | 80 | 120 | 1,6-hexanediol | 1 | 2.2 | 75 | 25 | 1,6-hexanediol | 0.3 | 1.1 | 16 | 167 |
| | | | diacrylate | | | | | diacrylate | | | | |
| (7) | 80 | 120 | Divinylbenzene | 4.5 | 2.2 | 75 | 25 | Divinylbenzene | 2 | 1.1 | 17 | 169 |

TABLE 3-1

| | Carboxylic acid | | | | | | | Alcohol | | | | | | |
|---|---|---|---|---|---|---|---|---|---|---|---|---|---|---|
| | Monomer (A) | | Others | | | | | Monomer (B) | | Others | | | | |
| Amorphous | | Propor- | | Propor- | | | | | Propor- | | Propor- | BPA- | BPA- | BPA- |
| PES resin | | tion | | tion | TPA | IPA | TMA | | tion | | tion | 2PO | 3PO | 2EO |
| particle | Type | % by | Type | % by | % by | % by | % by | Type | % by | Type | % by | % by | % by | % by |
| dispersion | — | mole | — | mole | mole | mole | mole | — | mole | — | mole | mole | mole | mole |
| (1) | Adipic acid | 3 | — | 0 | 25 | 19 | 2 | — | 0 | — | 0 | 31 | 20 | 0 |
| (2) | Adipic acid | 2 | — | 0 | 25 | 20 | 2 | 1,10- | 2 | — | 0 | 10 | 29 | 10 |
| | | | | | | | | Decanediol | | | | | | |
| (3) | Sebacic acid | 4 | — | 0 | 31 | 12 | 2 | 1,4- | 6 | — | 0 | 19 | 24 | 2 |
| | | | | | | | | Butanediol | | | | | | |
| (4) | Sebacic acid | 0.4 | — | 0 | 30 | 16.6 | 2 | 1,4- | 0.1 | — | 0 | 30 | 20.9 | 0 |
| | | | | | | | | Butanediol | | | | | | |
| (5) | Glutaric acid | 7.3 | — | 0 | 39.7 | 0 | 2 | — | 0 | — | 0 | 31 | 20 | 0 |
| (6) | Dodecanedioic | 1 | — | 0 | 46 | 0 | 2 | — | 0 | — | 0 | 31 | 20 | 0 |
| | acid | | | | | | | | | | | | | |
| (7) | Glutaric acid | 7.5 | — | 0 | 39.5 | 0 | 2 | — | 0 | — | 0 | 31 | 20 | 0 |
| (8) | Dodecanedioic | 0.8 | — | 0 | 46.2 | 0 | 2 | — | 0 | — | 0 | 31 | 20 | 0 |
| | acid | | | | | | | | | | | | | |
| (9) | Glutaric acid | 4.9 | — | 0 | 42.1 | 0 | 2 | — | 0 | — | 0 | 31 | 20 | 0 |
| (10) | Dodecanedioic | 1.5 | — | 0 | 45.5 | 0 | 2 | — | 0 | — | 0 | 31 | 20 | 0 |
| | acid | | | | | | | | | | | | | |
| (11) | Adipic acid | 4 | — | 0 | 25 | 19 | 2 | — | 0 | — | 0 | 30 | 20 | 0 |
| (12) | Adipic acid | 2 | — | 0 | 24 | 20 | 2 | 1,10- | 2 | — | 0 | 10 | 30 | 10 |
| | | | | | | | | Decanediol | | | | | | |
| (13) | — | 0 | — | 0 | 25 | 22 | 2 | — | 0 | — | 0 | 31 | 20 | 0 |
| (14) | Sebacic acid | 5 | — | 0 | 30 | 12 | 2 | 1,4- | 6 | — | 0 | 20 | 21 | 4 |
| | | | | | | | | Butanediol | | | | | | |
| (15) | Sebacic acid | 0.2 | — | 0 | 30 | 16.8 | 2 | 1,4- | 0.2 | — | 0 | 30 | 20.8 | 0 |
| | | | | | | | | Butanediol | | | | | | |
| (16) | Adipic acid | 5 | — | 0 | 40 | 0 | 4 | — | 0 | — | 0 | 20 | 31 | 0 |
| (17) | Adipic acid | 1 | — | 0 | 30 | 18 | 0 | — | 0 | — | 0 | 10 | 41 | 0 |
| (18) | — | 0 | 1,14- | 2 | 40 | 5 | 2 | — | 0 | 1,14- | 2 | 0 | 34 | 15 |
| | | | Tetradec- | | | | | | | Tetradec- | | | | |
| | | | anedicar- | | | | | | | anediol | | | | |
| | | | boxylic | | | | | | | | | | | |
| | | | acid | | | | | | | | | | | |
| (19) | Adipic acid | 6 | — | 0 | 25 | 16 | 2 | — | 0 | — | 0 | 31 | 20 | 0 |

TABLE 3-2

| | | (A)/all | Amorphous PES resin | | |
|---|---|---|---|---|---|
| Amorphous PES resin | (A) + (B)/all monomers | carboxylic acids | Acid value | Tg | Mw |
| particle dispersion | % by mole | % by mole | mgKOH/g | ° C. | — |
| (1) | 3.0 | 6.1 | 10 | 61 | 25000 |
| (2) | 4.0 | 4.1 | 10 | 61 | 28000 |
| (3) | 10.0 | 8.2 | 10 | 57 | 30000 |
| (4) | 0.5 | 0.8 | 10 | 62 | 29000 |
| (5) | 7.3 | 14.9 | 10 | 58 | 33000 |
| (6) | 1.0 | 2.0 | 10 | 60 | 31000 |
| (7) | 7.5 | 15.3 | 10 | 56 | 32000 |
| (8) | 0.8 | 1.6 | 10 | 62 | 28000 |
| (9) | 4.9 | 10.0 | 10 | 59 | 34000 |
| (10) | 1.5 | 3.1 | 10 | 60 | 33000 |
| (11) | 4.0 | 8.0 | 14 | 60 | 26000 |
| (12) | 4.0 | 4.2 | 7 | 60 | 24000 |
| (13) | 0.0 | 0.0 | 10 | 62 | 28000 |
| (14) | 11.0 | 10.2 | 10 | 58 | 25000 |
| (15) | 0.4 | 0.4 | 10 | 62 | 31000 |
| (16) | 5.0 | 10.2 | 10 | 60 | 58000 |
| (17) | 1.0 | 2.0 | 10 | 61 | 13000 |
| (18) | 0.0 | 0.0 | 10 | 56 | 30000 |
| (19) | 6.0 | 12.2 | 10 | 57 | 24000 |

TABLE 4-1

| | Material of toner particles | | | | | | | | |
|---|---|---|---|---|---|---|---|---|---|
| | | | | | Internally-added | | | | |
| | Amorphous PES resin | | Crystalline PES resin | | crosslinked resin | | | | |
| Toner | particle dispersion | | particle dispersion | | particle dispersion | | Aggregating agent | | CHELEST 40 |
| Type | Type | Amount | Type | Amount | Type | Amount | Type | Amount | Amount |
| — | — | Part by mass | — | Part by mass | — | Part by mass | — | Part by mass | Part by mass |
| (1) | (1) | 61.7 | (1) | 15.4 | (1) | 10 | 1% Al sulfate aqueous solution | 12 | 0.62 |
| (2) | (2) | 61.7 | (1) | 15.4 | (1) | 10 | 1% Al sulfate aqueous solution | 12 | 0.62 |
| (3) | (3) | 69.8 | (1) | 12.3 | (6) | 5 | 1% Al sulfate aqueous solution | 12 | 0.62 |
| (4) | (1) | 60.1 | (1) | 17.0 | (7) | 10 | 1% Al sulfate aqueous solution | 12 | 0.62 |
| (5) | (1) | 63.2 | (1) | 13.9 | (6) | 10 | 1% Al sulfate aqueous solution | 12 | 0.62 |
| (6) | (1) | 57.7 | (1) | 14.4 | (7) | 15 | 1% Al sulfate aqueous solution | 12 | 0.62 |
| (7) | (4) | 61.7 | (1) | 15.4 | (1) | 10 | 1% Al sulfate aqueous solution | 12 | 0.62 |
| (8) | (3) | 61.7 | (1) | 15.4 | (1) | 10 | 1% Al sulfate aqueous solution | 12 | 0.62 |
| (9) | (8) | 61.7 | (1) | 15.4 | (1) | 10 | 1% Al sulfate aqueous solution | 12 | 0.62 |
| (10) | (6) | 61.7 | (1) | 15.4 | (1) | 10 | 1% Al sulfate aqueous solution | 12 | 0.62 |
| (11) | (10) | 61.7 | (1) | 15.4 | (1) | 10 | 1% Al sulfate aqueous solution | 12 | 0.62 |
| (12) | (9) | 61.7 | (1) | 15.4 | (1) | 10 | 1% Al sulfate aqueous solution | 12 | 0.62 |
| (13) | (5) | 61.7 | (1) | 15.4 | (1) | 10 | 1% Al sulfate aqueous solution | 12 | 0.62 |
| (14) | (7) | 61.7 | (1) | 15.4 | (1) | 10 | 1% Al sulfate aqueous solution | 12 | 0.62 |
| (15) | (1) | 61.7 | (1) | 15.4 | (6) | 10 | 1% Al sulfate aqueous solution | 12 | 0.74 |
| (16) | (1) | 54.1 | (1) | 18.0 | (6) | 7 | 1% Al sulfate aqueous solution | 12 | 0.74 |
| (17) | (1) | 61.7 | (1) | 15.4 | (2) | 10 | 1% Al sulfate aqueous solution | 12 | 0.62 |
| (18) | (1) | 61.7 | (1) | 15.4 | (3) | 10 | 1% Al sulfate aqueous solution | 12 | 0.62 |
| (19) | (1) | 61.7 | (1) | 15.4 | (4) | 10 | 1% Al sulfate aqueous solution | 12 | 0.62 |
| (20) | (1) | 61.7 | (1) | 15.4 | (5) | 10 | 1% Al sulfate aqueous solution | 12 | 0.62 |
| (21) | (1) | 70.9 | (1) | 6.2 | (1) | 10 | 1% Al sulfate aqueous solution | 12 | 0.62 |
| (22) | (1) | 54.0 | (1) | 23.1 | (1) | 10 | 1% Al sulfate aqueous solution | 12 | 0.62 |
| (23) | (1) | 69.4 | (1) | 7.7 | (1) | 10 | 1% Al sulfate aqueous solution | 12 | 0.62 |
| (24) | (1) | 51.7 | (1) | 25.4 | (1) | 10 | 1% Al sulfate aqueous solution | 12 | 0.62 |
| (25) | (12) | 61.7 | (1) | 15.4 | (1) | 10 | 1% Al sulfate aqueous solution | 12 | 0.43 |
| (26) | (12) | 61.7 | (1) | 15.4 | (1) | 10 | 1% Al sulfate aqueous solution | 12 | 0.62 |
| (27) | (12) | 61.7 | (1) | 15.4 | (1) | 10 | 1% Al sulfate aqueous solution | 12 | 0.78 |
| (28) | (12) | 61.7 | (1) | 15.4 | (1) | 10 | 1% Al sulfate aqueous solution | 12 | 0.88 |
| (29) | (11) | 61.7 | (1) | 15.4 | (1) | 10 | 1% Al sulfate aqueous solution | 12 | 0.38 |
| (30) | (11) | 61.7 | (1) | 15.4 | (1) | 10 | 1% Al sulfate aqueous solution | 12 | 0.40 |
| (31) | (11) | 61.7 | (1) | 15.4 | (1) | 10 | 1% Al sulfate aqueous solution | 12 | 0.51 |
| (32) | (11) | 61.7 | (1) | 15.4 | (1) | 10 | 1% Al sulfate aqueous solution | 12 | 0.62 |
| (33) | (16) | 30.8 | (1) | 15.4 | (1) | 10 | 1% Al sulfate aqueous solution | 12 | 0.62 |
| | (17) | 30.8 | | | | | | | |
| (34) | (13) | 30.8 | (1) | 15.4 | (1) | 10 | 1% Al sulfate aqueous solution | 12 | 0.62 |
| | (19) | 30.8 | | | | | | | |
| (35) | (1) | 61.7 | (1) | 15.4 | (1) | 10 | 1% Mg chloride aqueous solution | 12 | 0.62 |
| (36) | (1) | 61.7 | (1) | 15.4 | (1) | 10 | 1% Ca chloride aqueous solution | 12 | 0.62 |
| (37) | (11) | 61.7 | (1) | 15.4 | (1) | 10 | 1% Al sulfate aqueous solution | 12 | 0.65 |
| (38) | (13) | 61.7 | (1) | 15.4 | (1) | 10 | 1% Al sulfate aqueous solution | 12 | 0.62 |
| (39) | (14) | 61.7 | (1) | 15.4 | (1) | 10 | 1% Al sulfate aqueous solution | 12 | 0.62 |
| (40) | (18) | 61.7 | (1) | 15.4 | (1) | 10 | 1% Al sulfate aqueous solution | 12 | 0.62 |
| (41) | (15) | 61.7 | (1) | 15.4 | (1) | 10 | 1% Al sulfate aqueous solution | 12 | 0.62 |
| (C1) | (1) | 69.8 | (1) | 12.3 | (6) | 5 | 1% Al sulfate aqueous solution | 12 | 0.93 |
| (C2) | (1) | 57.7 | (1) | 14.4 | (7) | 15 | 1% Al sulfate aqueous solution | 12 | 0.74 |

TABLE 4-2

| | Characteristics of toner particles | | | | | | | | |
|---|---|---|---|---|---|---|---|---|---|
| | | | | | | Internally-added crosslinked | | | |
| | | Amorphous PES resin | | | Crystalline resin | resin particles | | Metal ion (Al, Mg, Ca) | |
| Toner | Binder resin | | (A) + (B)/all | (A)/all carboxylic | Proportion in | Proportion in | | Total | |
| Type | Acid value AV1 | Type | monomers | acids | binder resin | toner particles | Tg | amount M1 | AV1/M1 |
| — | mgKOH/g | — | % by mole | % by mole | % by mass | % by mass | ° C. | % by mass | ×10³ |
| (1) | 9.8 | (1) | 3.0 | 6.1 | 20 | 10 | 17 | 0.0030 | 3.3 |
| (2) | 9.8 | (2) | 4.0 | 4.1 | 20 | 10 | 17 | 0.0030 | 3.3 |
| (3) | 9.8 | (3) | 10.0 | 8.2 | 15 | 5 | 16 | 0.0030 | 3.3 |
| (4) | 9.8 | (1) | 3.0 | 6.1 | 22 | 10 | 17 | 0.0030 | 3.3 |
| (5) | 9.8 | (1) | 3.0 | 6.1 | 18 | 10 | 16 | 0.0030 | 3.3 |
| (6) | 9.8 | (1) | 3.0 | 6.1 | 20 | 15 | 17 | 0.0030 | 3.3 |
| (7) | 9.8 | (4) | 0.5 | 0.8 | 20 | 10 | 17 | 0.0030 | 3.3 |
| (8) | 9.8 | (3) | 10.0 | 8.2 | 20 | 10 | 17 | 0.0030 | 3.3 |
| (9) | 9.8 | (8) | 0.8 | 1.6 | 20 | 10 | 17 | 0.0030 | 3.3 |
| (10) | 9.8 | (6) | 1.0 | 2.0 | 20 | 10 | 17 | 0.0030 | 3.3 |
| (11) | 9.8 | (10) | 1.5 | 3.1 | 20 | 10 | 17 | 0.0030 | 3.3 |
| (12) | 9.8 | (9) | 4.9 | 10.0 | 20 | 10 | 17 | 0.0030 | 3.3 |
| (13) | 9.8 | (5) | 7.3 | 14.9 | 20 | 10 | 17 | 0.0030 | 3.3 |
| (14) | 9.8 | (7) | 7.5 | 15.3 | 20 | 10 | 17 | 0.0030 | 3.3 |
| (15) | 9.8 | (1) | 3.0 | 6.1 | 20 | 10 | 16 | 0.0025 | 3.9 |
| (16) | 9.8 | (1) | 3.0 | 6.1 | 20 | 7 | 16 | 0.0025 | 3.9 |
| (17) | 9.8 | (1) | 3.0 | 6.1 | 20 | 10 | −3 | 0.0030 | 3.3 |
| (18) | 9.8 | (1) | 3.0 | 6.1 | 20 | 10 | 3 | 0.0030 | 3.3 |
| (19) | 9.8 | (1) | 3.0 | 6.1 | 20 | 10 | 37 | 0.0030 | 3.3 |
| (20) | 9.8 | (1) | 3.0 | 6.1 | 20 | 10 | 42 | 0.0030 | 3.3 |
| (21) | 9.8 | (1) | 3.0 | 6.1 | 8 | 10 | 17 | 0.0030 | 3.3 |
| (22) | 9.8 | (1) | 3.0 | 6.1 | 30 | 10 | 17 | 0.0030 | 3.3 |
| (23) | 9.8 | (1) | 3.0 | 6.1 | 10 | 10 | 17 | 0.0030 | 3.3 |
| (24) | 9.8 | (1) | 3.0 | 6.1 | 33 | 10 | 17 | 0.0030 | 3.3 |
| (25) | 7.4 | (12) | 4.0 | 4.2 | 20 | 10 | 17 | 0.0080 | 0.9 |
| (26) | 7.4 | (12) | 4.0 | 4.2 | 20 | 10 | 17 | 0.0050 | 1.5 |
| (27) | 7.4 | (12) | 4.0 | 4.2 | 20 | 10 | 17 | 0.0021 | 3.5 |
| (28) | 7.4 | (12) | 4.0 | 4.2 | 20 | 10 | 17 | 0.0015 | 4.9 |
| (29) | 13.0 | (11) | 4.0 | 8.0 | 20 | 10 | 17 | 0.0150 | 0.9 |
| (30) | 13.0 | (11) | 4.0 | 8.0 | 20 | 10 | 17 | 0.0130 | 1.0 |
| (31) | 13.0 | (11) | 4.0 | 8.0 | 20 | 10 | 17 | 0.0060 | 2.2 |
| (32) | 13.0 | (11) | 4.0 | 8.0 | 20 | 10 | 17 | 0.0030 | 4.3 |
| (33) | 9.8 | (16) | 3.0 | 6.1 | 20 | 10 | 17 | 0.0030 | 3.3 |
| | | (17) | | | | | | | |
| (34) | 9.8 | (13) | 3.0 | 6.1 | 20 | 10 | 17 | 0.0030 | 3.3 |
| | | (19) | | | | | | | |
| (35) | 9.8 | (1) | 3.0 | 6.1 | 20 | 10 | 17 | 0.0030 | 3.3 |
| (36) | 9.8 | (1) | 3.0 | 6.1 | 20 | 10 | 17 | 0.0030 | 3.3 |
| (37) | 13.0 | (11) | 4.0 | 8.0 | 20 | 10 | 17 | 0.0033 | 3.9 |
| (38) | 9.8 | (13) | 0.0 | 0.0 | 20 | 10 | 17 | 0.0030 | 3.3 |
| (39) | 9.8 | (14) | 11.0 | 10.2 | 20 | 10 | 17 | 0.0030 | 3.3 |
| (40) | 9.8 | (18) | 0.0 | 0.0 | 20 | 10 | 17 | 0.0030 | 3.3 |
| (41) | 9.8 | (15) | 0.4 | 0.4 | 20 | 10 | 17 | 0.0030 | 3.3 |
| (C1) | 9.8 | (1) | 3.0 | 6.1 | 15 | 5 | 16 | 0.0010 | 9.8 |
| (C2) | 9.8 | (1) | 3.0 | 6.1 | 20 | 15 | 17 | 0.0020 | 4.9 |

TABLE 4-3

| | | | Characteristics of toner | | | Image density |
|---|---|---|---|---|---|---|
| Developer | Carrier | Toner | tan δ(min) | tan δ(90) | tan δ(90)/tan δ(min) | stability |
| Example 2-1 | (1) | (1) | 0.85 | 1.65 | 1.9 | A |
| Example 2-2 | (1) | (2) | 0.82 | 1.68 | 2.0 | A |
| Example 2-3 | (1) | (3) | 1.00 | 2.40 | 2.4 | D |
| Example 2-4 | (1) | (4) | 0.60 | 1.58 | 2.6 | C |
| Example 2-5 | (1) | (5) | 0.89 | 2.00 | 2.2 | B+ |
| Example 2-6 | (1) | (6) | 0.50 | 1.27 | 2.5 | D |
| Example 2-7 | (1) | (7) | 0.83 | 1.66 | 2.0 | C |
| Example 2-8 | (1) | (8) | 0.83 | 1.67 | 2.0 | B |
| Example 2-9 | (1) | (9) | 0.82 | 1.66 | 2.0 | C |
| Example 2-10 | (1) | (10) | 0.84 | 1.60 | 1.9 | C+ |
| Example 2-11 | (1) | (11) | 0.81 | 1.57 | 1.9 | B+ |
| Example 2-12 | (1) | (12) | 0.83 | 1.60 | 1.9 | B++ |
| Example 2-13 | (1) | (13) | 0.84 | 1.66 | 2.0 | B+ |
| Example 2-14 | (1) | (14) | 0.83 | 1.64 | 2.0 | B |
| Example 2-15 | (1) | (15) | 0.92 | 2.30 | 2.5 | C+ |
| Example 2-16 | (1) | (16) | 0.96 | 2.52 | 2.6 | C |
| Example 2-17 | (1) | (17) | 0.91 | 1.65 | 1.8 | B |
| Example 2-18 | (1) | (18) | 0.89 | 1.68 | 1.9 | A |
| Example 2-19 | (1) | (19) | 0.81 | 1.70 | 2.1 | B+ |
| Example 2-20 | (1) | (20) | 0.77 | 1.61 | 2.1 | B+ |
| Example 2-21 | (1) | (21) | 0.95 | 1.50 | 1.6 | B |
| Example 2-22 | (1) | (22) | 0.70 | 1.74 | 2.5 | B+ |
| Example 2-23 | (1) | (23) | 0.90 | 1.66 | 1.8 | A |
| Example 2-24 | (1) | (24) | 0.60 | 1.80 | 3.0 | C |
| Example 2-25 | (1) | (25) | 0.74 | 1.37 | 1.9 | A |
| Example 2-26 | (1) | (26) | 0.85 | 1.70 | 2.0 | A |
| Example 2-27 | (1) | (27) | 0.90 | 1.99 | 2.2 | B+ |
| Example 2-28 | (1) | (28) | 0.94 | 2.52 | 2.7 | C |
| Example 2-29 | (1) | (29) | 0.70 | 1.29 | 1.8 | A |
| Example 2-30 | (1) | (30) | 0.77 | 1.33 | 1.7 | A |
| Example 2-31 | (1) | (31) | 0.87 | 1.76 | 2.0 | A |
| Example 2-32 | (1) | (32) | 0.90 | 2.40 | 2.7 | B |
| Example 2-33 | (1) | (33) | 0.86 | 1.66 | 1.9 | A |
| Example 2-34 | (1) | (34) | 0.86 | 1.69 | 2.0 | A |
| Example 2-35 | (1) | (35) | 0.85 | 1.65 | 1.9 | A |
| Example 2-36 | (1) | (36) | 0.85 | 1.65 | 1.9 | A |
| Example 2-37 | (1) | (37) | 0.90 | 2.25 | 2.5 | B+ |
| Example 2-38 | (1) | (38) | 0.83 | 1.70 | 2.0 | C+ |
| Example 2-39 | (1) | (39) | 0.81 | 1.66 | 2.0 | C++ |
| Example 2-40 | (1) | (40) | 0.85 | 1.70 | 2.0 | C+ |
| Example 2-41 | (1) | (41) | 0.85 | 1.69 | 2.0 | C+ |
| Comparative | (1) | (C1) | 1.10 | 2.37 | 2.2 | E |
| Example 2-1 | | | | | | |
| Comparative | (1) | (C2) | 0.48 | 1.45 | 3.0 | E |
| Example 2-2 | | | | | | |

The electrostatic charge image developer, the process cartridge, the image forming apparatus, and the image forming method according to the present disclosure include the following aspects. Each formula is the same as the formula having the same number described above.

### Supplementary Notes

(((1)))

An electrostatic charge image developer comprising:
a carrier; and
a toner,
wherein the carrier has magnetic particles, a resin coating layer that coats the magnetic particles, and inorganic particles contained in the resin coating layer, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less, and
the toner contains toner particles, and in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.
   (((2)))

The electrostatic charge image developer according to (((1))),
wherein the inorganic particles are at least one selected from the group consisting of silica particles, titania particles, and alumina particles.
   (((3)))

The electrostatic charge image developer according to (((1))) or (((2))),
wherein the inorganic particles are silica particles having a surface subjected to a hydrophobization treatment.
   (((4)))

The electrostatic charge image developer according to any one of (((1))) to (((3))),
wherein a proportion of the inorganic particles in the resin coating layer is 15% by mass or more and 35% by mass or less.
   (((5)))

The electrostatic charge image developer according to any one of (((1))) to (((4))),
wherein a value of B is 3.5 atm % or more and 12.0 atm % or less.
   (((6)))

The electrostatic charge image developer according to any one of (((1))) to (((5))),
wherein the value of B−A is 1.2 atm % or more and 2.3 atm % or less.
   (((7)))

The electrostatic charge image developer according to any one of (((1))) to (((6))),
wherein the minimal value tan δ(min) of the loss tangent is 0.60 or more and 0.96 or less.
   (((8)))

The electrostatic charge image developer according to any one of (((1))) to (((7))),
wherein a ratio tan δ(90)/tan δ(min) of a loss tangent tan δ(90) at a temperature of 90° C. to the minimal value tan δ(min) of the loss tangent is 2.5 or less.
   (((9)))

The electrostatic charge image developer according to any one of (((1))) to (((8))),
wherein the toner particles contains an amorphous polyester resin as a binder resin,
the amorphous polyester resin includes an amorphous polyester resin (S) having at least one of a constitutional unit represented by Formula (A) or a constitutional unit represented by Formula (B), and
a total proportion of the constitutional unit represented by Formula (A) and the constitutional unit represented by Formula (B) in all constitutional units constituting the amorphous polyester resin contained in the toner particles is 0.5% by mole or more and 10.0% by mole or less.
   (((10)))

The electrostatic charge image developer according to (((9))),
wherein a proportion of the constitutional unit represented by Formula (A) in all carboxylic acid units constituting the amorphous polyester resin contained in the toner particles is 2.0% by mole or more and 15.0% by mole or less.
   (((11)))

A process cartridge comprising:
a developing device that contains the electrostatic charge image developer according to any one of (((1))) to (((10))) and develops an electrostatic charge image formed on a surface of an image holder as a toner image using the electrostatic charge image developer,
wherein the process cartridge is detachable from an image forming apparatus.
   (((12)))

An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to any one of (((1))) to (((10))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.
   (((13)))

An image forming method comprising:
charging a surface of an image holder;
forming an electrostatic charge image on the charged surface of the image holder;
developing the electrostatic charge image formed on the surface of the image holder as a toner image using the electrostatic charge image developer according to any one of (((1))) to (((10)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developer comprising:
a carrier; and
a toner,
wherein the carrier has magnetic particles, a resin coating layer that coats the magnetic particles, and inorganic particles contained in the resin coating layer, and in a case where an element ratio of metals and metalloids, that constitute the inorganic particles, is analyzed by X-ray photoelectron spectroscopy in a depth direction, and the element ratio at 0 seconds of etching is defined as A and the element ratio at 300 seconds of etching is defined as B, a value of B−A is 0.5 atm % or more and 3.0 atm % or less, and
the toner contains toner particles, and in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.

2. The electrostatic charge image developer according to claim 1,
wherein the inorganic particles are at least one selected from the group consisting of silica particles, titania particles, and alumina particles.

3. The electrostatic charge image developer according to claim 1,
wherein the inorganic particles are silica particles having a surface subjected to a hydrophobization treatment.

4. The electrostatic charge image developer according to claim 1,
wherein a proportion of the inorganic particles in the resin coating layer is 15% by mass or more and 35% by mass or less.

5. The electrostatic charge image developer according to claim 1,
wherein a value of B is 3.5 atm % or more and 12.0 atm % or less.

6. The electrostatic charge image developer according to claim 1,
wherein the value of B−A is 1.2 atm % or more and 2.3 atm % or less.

7. The electrostatic charge image developer according to claim 1,
wherein the minimal value tan δ(min) of the loss tangent is 0.60 or more and 0.96 or less.

8. The electrostatic charge image developer according to claim 1,
wherein a ratio tan δ(90)/tan δ(min) of a loss tangent tan δ(90) at a temperature of 90° C. to the minimal value tan δ(min) of the loss tangent is 2.5 or less.

9. The electrostatic charge image developer according to claim 1,
wherein the toner particles contains an amorphous polyester resin as a binder resin,
the amorphous polyester resin includes an amorphous polyester resin (S) having at least one of a constitutional unit represented by Formula (A) or a constitutional unit represented by Formula (B), and
a total proportion of the constitutional unit represented by Formula (A) and the constitutional unit represented by Formula (B) in all constitutional units constituting the amorphous polyester resin contained in the toner particles is 0.5% by mole or more and 10.0% by mole or less, 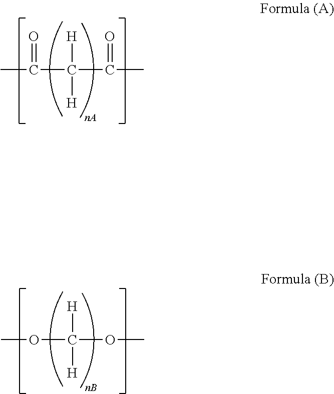
nA in Formula (A) is an integer of 2 or more and 12 or less,
nB in Formula (B) is an integer of 2 or more and 12 or less.

10. The electrostatic charge image developer according to claim 9,
wherein a proportion of the constitutional unit represented by Formula (A) in all carboxylic acid units constituting the amorphous polyester resin contained in the toner particles is 2.0% by mole or more and 15.0% by mole or less.

11. A process cartridge comprising:
a developing device that contains the electrostatic charge image developer according to claim 1 and develops an electrostatic charge image formed on a surface of an image holder as a toner image using the electrostatic charge image developer,
wherein the process cartridge is detachable from an image forming apparatus.

12. A process cartridge comprising:
a developing device that contains the electrostatic charge image developer according to claim 2 and develops an electrostatic charge image formed on a surface of an image holder as a toner image using the electrostatic charge image developer,
wherein the process cartridge is detachable from an image forming apparatus.

13. A process cartridge comprising:
a developing device that contains the electrostatic charge image developer according to claim 3 and develops an electrostatic charge image formed on a surface of an image holder as a toner image using the electrostatic charge image developer,
wherein the process cartridge is detachable from an image forming apparatus.

14. A process cartridge comprising:
a developing device that contains the electrostatic charge image developer according to claim 4 and develops an electrostatic charge image formed on a surface of an image holder as a toner image using the electrostatic charge image developer,
wherein the process cartridge is detachable from an image forming apparatus.

15. A process cartridge comprising:
a developing device that contains the electrostatic charge image developer according to claim 5 and develops an electrostatic charge image formed on a surface of an image holder as a toner image using the electrostatic charge image developer,
wherein the process cartridge is detachable from an image forming apparatus.

16. A process cartridge comprising:
a developing device that contains the electrostatic charge image developer according to claim 6 and develops an electrostatic charge image formed on a surface of an image holder as a toner image using the electrostatic charge image developer,
wherein the process cartridge is detachable from an image forming apparatus.

17. A process cartridge comprising:
a developing device that contains the electrostatic charge image developer according to claim 7 and develops an electrostatic charge image formed on a surface of an image holder as a toner image using the electrostatic charge image developer,
wherein the process cartridge is detachable from an image forming apparatus.

18. A process cartridge comprising:
a developing device that contains the electrostatic charge image developer according to claim 8 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 1 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 1;
transferring the toner image formed on the surface of the image holder to a surface of a recording medium; and
fixing the toner image transferred to the surface of the recording medium.
